(19) United States
(12) Patent Application Publication
(10) Pub. No.: US 2024/0088349 A1
(43) Pub. Date: Mar. 14, 2024

(54) METHOD OF MANUFACTURING A NEGATIVE ELECTRODE ACTIVE MATERIAL

(71) Applicant: MURATA MANUFACTURING CO., LTD., Kyoto (JP)

(72) Inventor: Daisuke ITO, Kyoto (JP)

(21) Appl. No.: 18/511,355

(22) Filed: Nov. 16, 2023

Related U.S. Application Data
(62) Division of application No. 16/456,506, filed on Jun. 28, 2019, now abandoned.
Application No. 16/456,506 is a continuation of application No. PCT/JP2017/041303, filed on Nov. 16, 2017.

(30) Foreign Application Priority Data
Dec. 29, 2016 (JP) 2016-257377

(51) Int. Cl. H01M 4/131; H01M 4/134; H01M 4/139; H01M 4/60; H01M 10/0525; H01M 10/42; H01M 10/625

(52) U.S. Cl. CPC H01M 4/131; H01M 4/134; H01M 4/139; H01M 4/606; H01M 10/0525; H01M 10/4257; H01M 10/625; H01M 2004/027

(57) ABSTRACT

A method for manufacturing a negative electrode active material is provided. The method includes reacting a compound capable of forming a complex with lithium and a negative electrode active material containing lithium and silicon.

### CROSS-REFERENCE TO RELATED APPLICATIONS

The present application is a division of U.S. patent application Ser. No. 16/456,506, filed on Jun. 28, 2019, which is a continuation of PCT application PCT/JP2017/041303, filed on Nov. 16, 2017, which claims priority to Japanese Application No. 2016-257377, filed Dec. 29, 2016, the entire contents of which are incorporated herein by reference.

### TECHNICAL FIELD

The present art relates to a negative electrode active material and a method for manufacturing the same, a negative electrode, a battery, a battery pack, an electronic device, an electrically driven vehicle, a power storage apparatus, and a power system.

### BACKGROUND ART

At present, it is urgently required to develop a technique to increase the capacity of lithium ion secondary batteries. Development of Si-based materials as a negative electrode material having a higher capacity than carbon-based materials is underway worldwide. Among Si-based materials, silicon oxide (SiOₓ) is mentioned as one of the materials exhibiting the most favorable cycle characteristics. Silicon oxide has an advantage that the stability of Si—O—Si bond by oxygen can suppress the structural collapse due to expansion and contraction. On the other hand, silicon oxide also has a disadvantage that the lithium trap phenomenon due to oxygen occurs and lithium loss occurs. Lithium loss to be approximately the same molar ratio as that of oxygen occurs, and the initial charge and discharge efficiency drops to 68%. These are contradictory functions, and lithium loss is unavoidable in most Si-based materials into which oxygen is introduced.

Hence, a technique to pre-dope silicon oxide with lithium has been proposed. For example, Patent Document 1 proposes a technique to insert lithium into a silicon-based material while regulating the potential and the current as a technique to pre-dope lithium.

### PRIOR ART DOCUMENT

### Patent Document

Patent Document 1: Japanese Patent Application Laid-Open No. 2015-111547

### SUMMARY OF THE INVENTION

### Problem to be Solved by the Invention

However, there is a possibility that lithium is eluted when silicon oxide is pre-doped with lithium. In addition, there is the same possibility that lithium is eluted in a case in which tin oxide and germanium oxide as a negative electrode active material are pre-doped with lithium as well.

An object of the present art is to provide a negative electrode active material from which the elution of lithium can be suppressed, a method for manufacturing negative electrode active material, a negative electrode, a battery, and a battery pack, an electronic device, an electrically driven vehicle, a power storage apparatus, and a power system which include the battery.

### Means for Solving the Problem

In order to solve the above-mentioned problems, a first art is a negative electrode active material having a compound capable of forming a complex with lithium on a surface.

A second art is a method for manufacturing a negative electrode active material, which includes reacting a compound capable of forming a complex with lithium with a negative electrode active material containing lithium.

A third art is a negative electrode containing the negative electrode active material of the first art.

A fourth art is a battery including a negative electrode containing the negative electrode active material of the first art, a positive electrode, and an electrolyte.

A fifth art is a battery pack including the battery of the fourth art and a control unit configured to control the battery.

A sixth art is an electronic device which includes the battery of the fourth art and receives power supply from the battery.

A seventh art is an electrically driven vehicle including the battery of the fourth art, a converter configured to receive power supply from the battery and convert the power into a driving force of the vehicle, and a controller configured to perform information processing on vehicle control based on information on the battery.

An eighth art is a power storage apparatus which includes the battery of the fourth art and supplies power to an electronic device connected to the battery.

A ninth art is a power system which includes the battery of the fourth art and receives power supply from the battery.

### Advantageous Effect of the Invention

According to the present art, it is possible to suppress the elution of lithium from the negative electrode active material. Incidentally, the effects described herein are not necessarily limited and may be any of the effects described in the present disclosure or effects different from these.

### BRIEF EXPLANATION OF DRAWINGS

FIG. 1 is a cross-sectional diagram illustrating an example of the configuration of a negative electrode active material according to a first embodiment of the present art.

FIG. 2A is a conceptual diagram of a negative electrode active material particle containing SiOₓ. FIG. 2B is a conceptual diagram of a negative electrode active material particle pre-doped with lithium. FIG. 2C is a conceptual diagram of a negative electrode active material particle treated with naphthalene. FIG. 2D is a conceptual diagram of a negative electrode active material particle washed with water.

FIG. 3A is a schematic diagram illustrating a model of naphthalene-catalyzed cycle reaction. FIG. 3B is a conceptual diagram illustrating a process of naphthalene-catalyzed cycle reaction.

FIGS. 4A and 4B are graphs illustrating the relation between the sequence in step charge and discharge analysis and the calculated charge voltage and the irreversible capacity ratio.

FIG. 5 is a schematic diagram illustrating a model of a reaction to chelate movable lithium.

FIG. 6 is a cross-sectional diagram illustrating an example of the configuration of a non-aqueous electrolyte secondary battery according to a second embodiment of the present art.

FIG. 7 is an enlarged cross-sectional diagram illustrating a part of the wound electrode assembly illustrated in FIG. 6.

FIG. 8 is an exploded perspective diagram illustrating an example of the configuration of a non-aqueous electrolyte secondary battery according to a third embodiment of the present art.

FIG. 9 is a cross-sectional diagram of a wound electrode assembly taken along the line IX-IX in FIG. 8.

FIGS. 10A and 10B are graphs illustrating XPS spectra (after Ar etching) of the interiors of negative electrode active materials of Examples 1-1 and 1-2 and Reference Examples 1-1 and 1-2, respectively.

FIGS. 11A and 11B are graphs illustrating XPS spectra of the surfaces of negative electrode active materials of Examples 1-1 and 1-2 and Reference Examples 1-1 and 1-2, respectively.

FIG. 12A is a graph illustrating the ToF-SIMS spectra of the surfaces of negative electrode active materials of Example 1-2 and Reference Example 1-1. FIG. 12B is a graph illustrating the results on the component analysis of the surfaces of negative electrode active materials of Example 1-2 and Reference Example 1-1 by ToF-SIMS.

FIGS. 13A, 13B, and 13C are graphs illustrating the evaluation results on the initial charge and discharge characteristics of coin cells of Reference Examples 2-1 and 2-2 and Example 2-2, respectively.

FIG. 14A is a graph illustrating dQ/dV curves of coin cells of Examples 2-1 and 2-2 and Reference Examples 2-1 and 2-2 at the time of initial charge. FIG. 14B is a graph illustrating dQ/dV curves of coin cells of Examples 2-1 and 2-2 and Reference Examples 2-1 and 2-2 at the time of initial discharge.

FIG. 15A is a graph illustrating the evaluation results on the cycle characteristics of coin cells of Example 2-2 and Reference Example 2-1. FIG. 15B is a graph illustrating the evaluation results on the average discharge voltage of coin cells of Example 2-2 and Reference Example 2-1.

FIG. 16 is a block diagram illustrating an example of the configuration of an electronic device as an application example.

FIG. 17 is a schematic diagram illustrating an example of the configuration of a power storage system in a vehicle as an application example.

FIG. 18 is a schematic diagram illustrating an example of the configuration of a power storage system in a house as an application example.

### MODE FOR CARRYING OUT THE INVENTION

The negative electrode active material of the present art contains lithium (Li), at least one of silicon (Si), tin (Sn), or germanium (Ge), and at least one of oxygen (O) or fluorine (F) and has a compound capable of forming a complex with lithium on the surface. The compound may be in a state of forming a complex with lithium.

The negative electrode active material may contain lithium, at least one of silicon, tin, or germanium, and oxygen and have a compound capable of forming a complex with lithium on the surface. In this case, the negative electrode active material may further contain fluorine, if necessary. In addition, the compound may be in a state of forming a complex with lithium.

The compound may be adsorbed onto the surface of the negative electrode active material. The adsorption is physisorption or chemisorption. In a case in which a plurality of the compounds are adsorbed onto the surface of the negative electrode active material, the plurality of compounds to be adsorbed may include both of those that are physically adsorbed onto the surface of the negative electrode active material and those that are chemically adsorbed onto the surface of the negative electrode active material.

Physisorption means adsorption between the surface of the negative electrode active material and the compound caused by the interaction such as van der Waals force, electrostatic attraction, and magnetic force. Chemisorption means adsorption between the surface of the negative electrode active material and the compound involving chemical bonds such as covalent bond, ionic bond, metal bond, coordinate bond, and hydrogen bond.

In a case in which the negative electrode active material contains lithium, at least one of silicon, tin, or germanium, and oxygen, lithium, at least one of silicon, tin, or germanium, and oxygen are, for example, at least one of lithium-containing SiOₓ (0.33<x<2), lithium-containing SnO_{y} (0.33<y<2), or lithium-containing SnO_{y} (0.33<y<2).

The content of lithium is preferably 10 at % or more and 45 at % or less. Here, the “content of lithium” means the content of lithium with respect to the total amount of lithium, at least one of silicon, tin, or germanium, and at least one of oxygen or fluorine.

The compound capable of forming a complex with lithium is, for example, at least one of an aromatic compound or a derivative thereof. The aromatic compound is preferably a condensed ring aromatic compound, and is, for example, at least one of acenes, phenanthrene, chrysene, triphenylene, tetraphene, pyrene, picene, pentaphene, perylene, helicene, or coronene. The acenes are, for example, at least one of naphthalene, anthracene, tetracene, pentacene, hexacene, or heptacene.

The negative electrode active material has, for example, a particulate shape, a layered shape, or a three-dimensional shape. In a case in which the active material has a particulate shape, the active material may be either of primary particles or secondary particles. Examples of the shape of the particles include a spherical shape, an ellipsoidal shape, a needle shape, a plate shape, a scale shape, a tubular shape, a wire shape, a pole shape (rod shape), or an irregular shape but are not particularly limited thereto. Incidentally, particles in two or more kinds of shapes may be used in combination. Here, the spherical shape includes not only a perfect spherical shape but also a shape in which a perfect spherical shape is slightly flattened or distorted, a shape in which concave and convex are formed on the surface of a perfect spherical shape, or a shape in which these shapes are combined. The ellipsoidal shape includes not only a strictly ellipsoidal shape but also a shape in which a strictly ellipsoidal shape is slightly flattened or distorted, a shape in which concave and convex are formed on the surface of a strictly ellipsoidal shape, or a shape in which these shapes are combined. The layered shape includes a thin film shape, a plate shape, or a sheet shape but it is not particularly limited thereto. Examples of the three-dimensional shape include a tubular shape such as a pole shape or a cylindrical shape, a shell shape such as a spherical shell shape, a curved shape, a polygonal shape, a mesh shape, or an irregular shape but are not particularly limited thereto.

The negative electrode active material may have a covering agent which covers at least a part of the surface of the negative electrode active material. The covering agent contains, for example, at least one of carbon, a hydroxide, an oxide, a carbide, a nitride, a fluoride, a hydrocarbon compound, or a polymer compound.

The content of the covering agent is preferably 0.05 mass % or more and 10 mass % or less and more preferably 0.1 mass % or more and 10 mass % or less. Here, the “content of the covering agent” means the content of the covering agent with respect to the entire negative electrode active material including the covering agent. The content of the covering agent is determined by specifying the kind of materials contained in the surface of the negative electrode active material particles by X-ray photoelectron spectroscopy (XPS), infrared spectroscopy (IR), time-of-flight secondary ion mass spectrometry (TOF-SIMS) and the like, then dissolving the negative electrode active material particles in an acidic solution such as hydrochloric acid, and measuring the contents of the respective elements contained in the negative electrode active material particles by inductively coupled plasma atomic emission spectroscopy (ICPAES).

The method for manufacturing a negative electrode active material of the present art includes reacting a compound capable of forming a complex with lithium and a negative electrode active material containing lithium. By the reaction, the compound forms a complex with lithium contained in the negative electrode active material and lithium is removed from the negative electrode active material.

The reaction is performed, for example, by immersing the negative electrode active material in a solution containing the compound. The solvent contained in the solution is not particularly limited as long as it can dissolve the compound, but an organic solvent such as a chain ether can be used. Examples of the chain ether include diethyl ether, diisopropyl ether, t-butyl methyl ether, dibutyl ether, and anisole. These solvents may be used singly or two or more kinds thereof may be used in combination.

The principle of the reaction is similar to the lithium naphthalenide synthesis. In the case of lithium naphthalenide synthesis, naphthalene forms a complex with lithium by immersing lithium metal in a naphthalene solution and lithium naphthalenide is formed as well as lithium is dissolved.

In contrast, in the method for manufacturing a negative electrode active material of the present art, a lithium-pre-doped negative electrode active material is used instead of lithium metal. In addition, the compound (organic complex precursor) capable of forming a complex with lithium is not limited to naphthalene and may be any of the compounds (organic complex precursors) capable of forming a complex with lithium contained in the negative electrode active material. Lithium which is likely to be eluted from the negative electrode active material complexes with the compound and can be removed from the negative electrode active material without being unsafe. At this time, the complexation reaction between the compound and the negative electrode active material is regulated by the respective redox potentials thereof and thus can be stabilized at a specific initial charge and discharge efficiency (amount of lithium).

It is also possible to finely control the initial charge and discharge efficiency by changing the kind of the compound. In addition, it is possible to increase the reaction rate and shorten the tact time of process by heating the solution. Conversely, it is also possible to decrease the reaction rate and diminish the error of the initial charge and discharge efficiency by lowering the temperature of the solution.

The negative electrode active material containing lithium is, for example, a negative electrode active material containing lithium, at least one of silicon, tin, or germanium, and at least one of oxygen or fluorine. The negative electrode active material containing lithium may be a negative electrode active material containing lithium, at least one of silicon, tin, or germanium, and oxygen and may further contain fluorine if necessary.

In a case in which the negative electrode active material contains lithium, at least one of silicon, tin, or germanium, and oxygen, the negative electrode active material contains, for example, at least one of lithium-containing SiOₓ (0.33<x<2), lithium-containing SnO_{y} (0.33<y<2), or lithium-containing SnO_{y} (0.33<y<2)

The negative electrode active material containing lithium is preferably fabricated by lithium pre-doping. The method of lithium pre-doping is not particularly limited as long as it is a method capable of pre-doping a negative electrode active material with lithium, but for example, a lithium metal mixing method, an electrochemical method, a thermal reaction method, and an organolithium method can be used. One of these methods may be used singly, or two or more of these methods may be used in combination. The lithium metal mixing method is a method in which lithium metal and a negative electrode active material are mixed together and lithium is inserted into the negative electrode active material. The thermal reaction method is a method in which lithium and a negative electrode active material are mixed together and fired and lithium is thermally inserted into the negative electrode active material. The organolithium method is a method in which a negative electrode active material is immersed in a solution containing highly reactive organolithium and lithium is inserted into the negative electrode active material.

Embodiments of the present are will be described in the following order.
1 First embodiment (example of negative electrode active material)
2 Second embodiment (example of cylindrical battery)
3 Third Embodiment (example of laminated film type battery)
4 Application Example 1 (battery pack and electronic device)
5 Application Example 2 (power storage system in vehicle)
6 Application Example 3 (power storage system in house)

### 1 First Embodiment

### [Configuration of Negative Electrode Active Material]

The negative electrode active material according to the first embodiment of the present art contains a powder of negative electrode active material particles. This negative electrode active material is, for example, for non-aqueous electrolyte secondary batteries such as lithium ion secondary batteries. This negative electrode active material may be used in a LiSi—S battery or a LiSi—Li₂S battery. The negative electrode active material particles contain lithium, silicon, and oxygen and have a compound capable of forming a complex with lithium contained in the negative electrode active material particles on the particle surface. The compound may be in a state of forming a complex with lithium on the particle surface. Lithium, silicon, and oxygen contained in the negative electrode active material particles are, for example, lithium-containing SiOₓ (0.33<x<2)

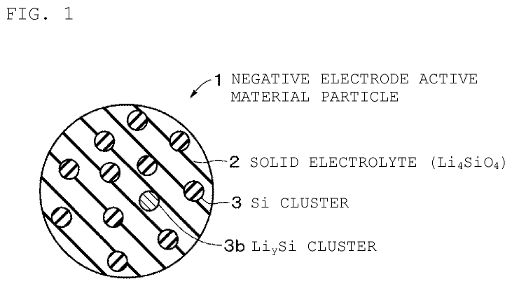

Negative electrode active material particles 1 are an ideal high-capacity material having a structure in which a nano-sized Si cluster 3 is embedded in a solid electrolyte 2 containing Li₄SiO₄ as illustrated in FIG. 1. Incidentally, the negative electrode active material particles 1 may further contain a nano-sized Li_{y}Si (0<y<3.75) cluster 3b. In this case, from the viewpoint of suppressing the elution of lithium, it is preferable that the content of Si cluster 3 in the negative electrode active material particles 1 is higher than the content of Li_{y}Si cluster 3b in the negative electrode active material particles 1 and it is more preferable that the negative electrode active material particles 1 hardly contain the Li_{y}Si cluster 3b.

The Si cluster 3 and the Li_{y}Si cluster 3b may have a concentration distribution. In this case, from the viewpoint of suppressing the elution of lithium, it is preferable that the concentration of Si cluster 3 is higher than the concentration of Li_{y}Si cluster 3b at the surface portion of the particles. Specifically, it is preferable that the concentration distribution of Si cluster 3 decreases from the surface to the center of the negative electrode active material particles 1 and the concentration distribution of Li_{y}Si cluster 3b increases from the surface to the center of the negative electrode active material particles 1.

### [Method for Manufacturing Negative Electrode Active Material]

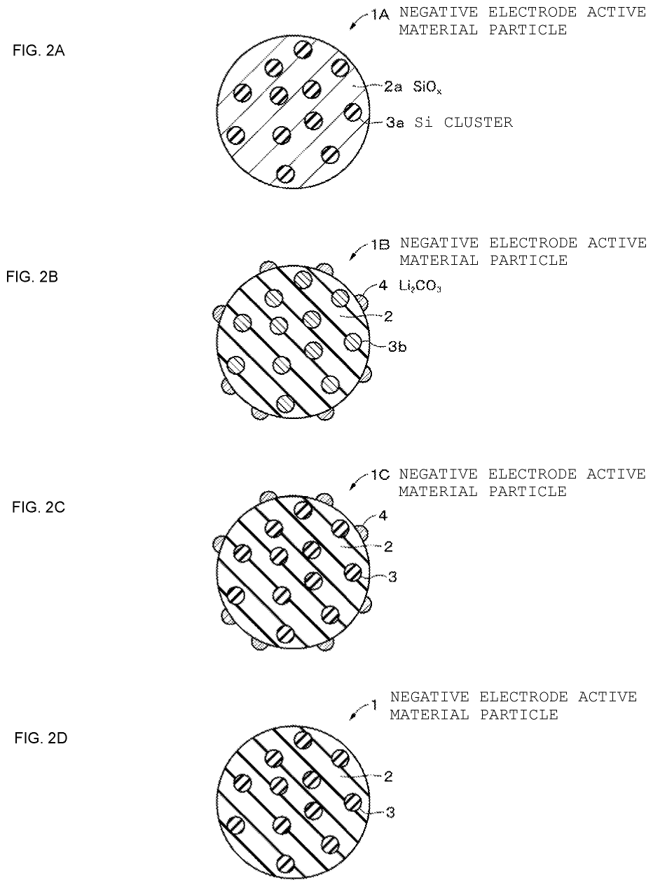

Hereinafter, an example of a method for manufacturing a negative electrode active material according to the first embodiment of the present art will be described with reference to FIGS. 2A to 2D, 3A, 3B, 4A, 4B, and 5.

### (Step of Preparing Negative Electrode Active Material)

First, a powder of negative electrode active material particles containing SiOₓ (0.33<x<2) is prepared as a negative electrode active material. Here, a case of using a powder of negative electrode active material particles containing SiOₓ as a negative electrode active material before being pre-doped with lithium is described, but the negative electrode active material is not limited to this.

FIG. 2A is a conceptual diagram of a negative electrode active material particle 1A containing SiOₓ. This negative electrode active material particle 1A has a structure in which a nano-sized Si cluster 3a is embedded in SiOₓ 2a.

### (Lithium Pre-Doping Step)

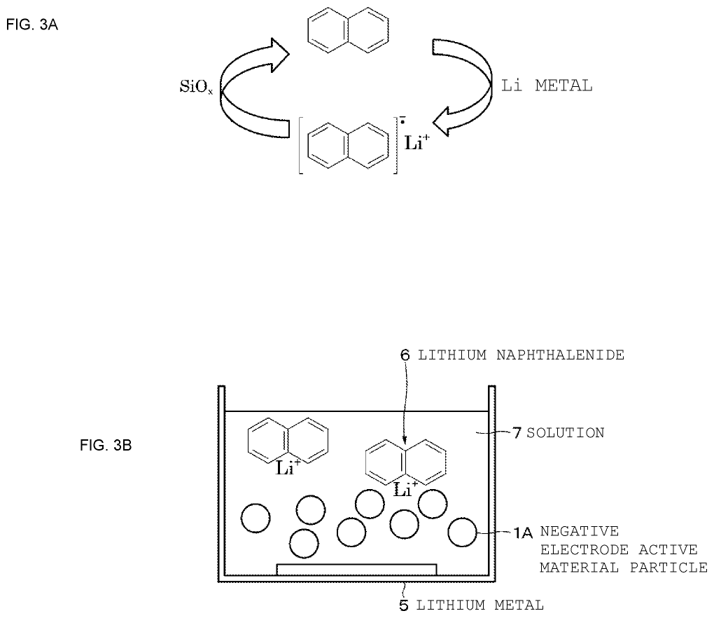

Next, the prepared negative electrode active material is subjected to a lithium pre-doping treatment by an organolithium method. Specifically, the lithiumpre-doping treatment is performed as follows. A brown or black solution 7 containing lithium naphthalenide 6 as organolithium is prepared by dissolving naphthalene as a condensed ring aromatic compound in a solvent such as an ether and then immersing lithium metal 5 in the solvent as illustrated in FIG. 3B. The powder of the negative electrode active material particles 1A is immersed in this solution 7 and the negative electrode active material particles 1A are pre-doped with lithium. By this, a powder of negative electrode active material particles containing lithium-containing SiOₓ (0.33<x<2) is obtained as a negative electrode active material pre-doped with lithium.

FIG. 2B is a conceptual diagram of a negative electrode active material particle 1B pre-doped with lithium. The negative electrode active material particle 1B pre-doped with lithium has a structure in which a nano-sized Li_{y}Si cluster 3b is embedded in a solid electrolyte 2 containing Li₄SiO₄. In addition, lithium carbonate (Li₂CO₃) 4 is usually formed on the surface of the negative electrode active material particle 1B pre-doped with lithium. The lithium pre-doping technique can be rephrased as a technique not only to compensate for lithium loss but also to convert SiOₓ 2a containing the Si cluster 3a into Li₄SiO₄ containing the Si cluster 3a.

Here, a case of using naphthalene as a condensed ring aromatic compound is described, but the kind of condensed ring aromatic compound may be a compound which can form a complex with lithium and deliver lithium ions to negative electrode active material particles containing SiOₓ 2a and is not limited to this. In addition, the compound may be a compound other than the condensed ring aromatic compound as long as it is a compound having the properties described above.

The reaction mechanism of naphthalene with lithium metal is a complex reaction by which the lithium ion is stabilized with the naphthalene anion radical utilizing the conjugated n electron of naphthalene, by-products are not produced as presented in Formula (1). Furthermore, the unstable oxygen group in SiOₓ 2a is in a nucleophilic state close to a radical anion, and thus lithium ions are easily delivered from lithium naphthalenide to SiOₓ 2a as presented in the Formula (2). At this time, naphthalenide returns to naphthalene after the pre-doping reaction. In other words, when Formulas (1) and (2) are combined, the reaction to pre-dope lithium can be regarded as a reaction catalyzed by naphthalene as presented in Formula (3).

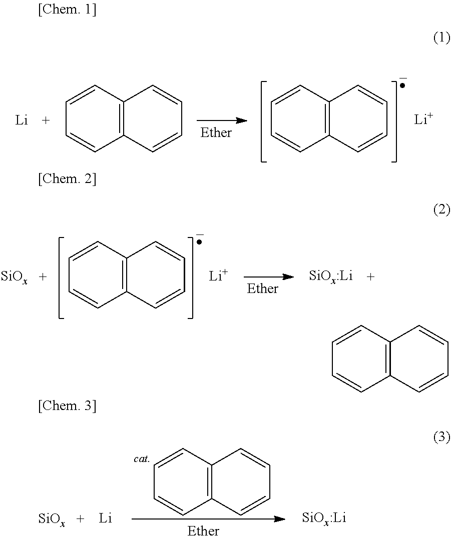

FIG. 3A is a schematic diagram illustrating a model of naphthalene-catalyzed cycle reaction. FIG. 3B is a conceptual diagram illustrating the process of naphthalene-catalyzed cycle reaction. The organolithium process can be greatly simplified when this naphthalene-catalyzed cycle reaction is utilized. It can be described as a model in which naphthalene delivers lithium from lithium metal 5 to SiOₓ contained in the negative electrode active material particles 1A as a catalyst. At this time, lithium donates an electron to naphthalene (1.86 V (vs Li/Li⁺)) and is weakly coordinated with a naphthalene anion radical to form lithium naphthalenide 6 (0.3 V (vs Li/Li⁺)). Meanwhile, with regard to the reaction potential of SiOₓ, it has been found that approximately all irreversible capacity components (bonding of oxygen with lithium) are charged to 0.3 V in the case of amorphous SiOₓ as a result of step charge and discharge analysis. In other words, lithium naphthalenide 6 (0.3 V (vs Li/Li⁺)) can electrochemically deliver lithium to SiOₓ when being in contact with SiOₓ (internal battery state) The naphthalene which has delivered lithium reacts with metal lithium again and lithium naphthalenide 6 is regenerated.

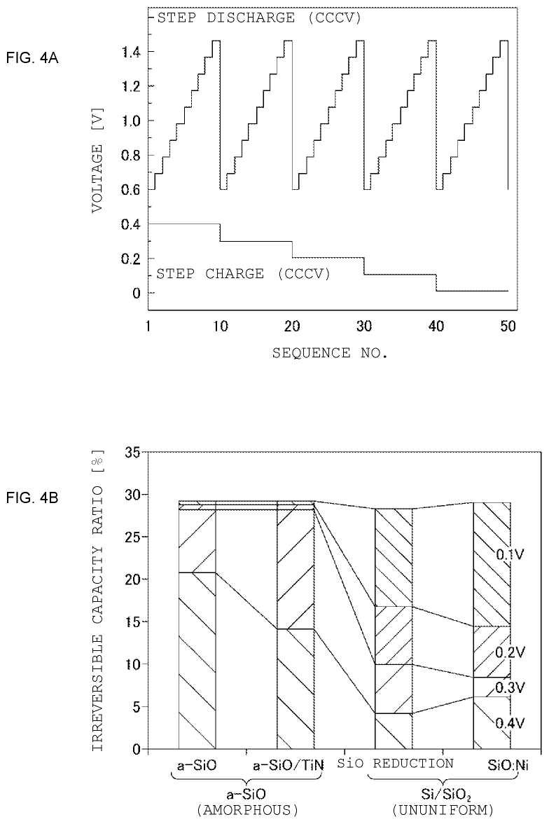

FIGS. 4A and 4B are graphs illustrating the relation between the sequence in step charge and discharge analysis and the calculated charge voltage and the irreversible capacity ratio. In the case of naphthalene-catalyzed cycle reaction, the amount of lithium required, for example, for the treatment of 1 kg of SiOₓ is the same 78 g (lithium ingot is sunk. Refilling in the middle is also possible), but the amount of naphthalene can be decreased to 1/100 (about 70 g) of lithium naphthalenide and the amount of solvent can be decreased to 1/40 (10 L). In addition, naphthalene and the solvent can be reused. In addition, precursors other than naphthalene can also be used, and for example, compounds having two or more benzene rings such as naphthalene derivatives, anthracene and derivatives thereof, and phenylbenzene can be used. The precursor can be selected in consideration of solubility, cost, and safety in addition to the reaction potential described above.

### (Step of Removing Movable Lithium)

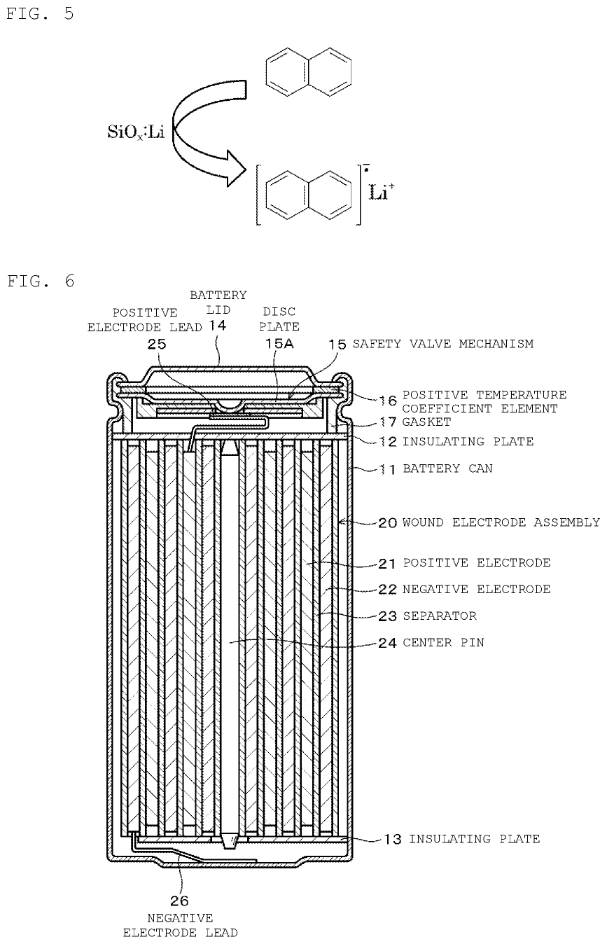

Next, movable lithium (excess lithium) is chelated by using the reverse reaction of the naphthalenide reaction. In other words, movable lithium (excess lithium) in the negative electrode active material is removed using naphthalene which is a compound (organic complex precursor) capable of forming a complex with lithium utilizing the reaction illustrated in FIG. 5. Specifically, a solution containing naphthalene is prepared, and the powder of the pre-doped negative electrode active material particles (namely, the powder of negative electrode active material particles containing lithium-containing SiOₓ (0.33<x<2)) is immersed in this solution. By this, naphthalene forms a complex with the excess lithium contained in the negative electrode active material particles and the excess lithium is removed from the negative electrode active material particles.

FIG. 2C is a conceptual diagram of a negative electrode active material particle 1C treated with naphthalene. This negative electrode active material particle 1C has a structure in which the Si cluster 3 is embedded in the solid electrolyte 2 containing Li₄SiO₄ which is a solid electrolyte. As described above, it is possible to withdraw lithium from the Li_{y}Si cluster 3b illustrated in FIG. 2B and convert the Li_{y}Si cluster 3b into the Si cluster 3 by treating the negative electrode active material particle 1B with naphthalene. Incidentally, lithium contained in the Li_{y}Si cluster 3b is the movable lithium (excess lithium) described above.

### (Step of Water Washing Treatment)

Finally, the negative electrode active material from which movable lithium has been removed is washed with water, if necessary. Incidentally, the water washing treatment is possible by removing the movable lithium in the previous step and stabilizing the negative electrode active material.

FIG. 2D is a conceptual diagram of the negative electrode active material particle 1 washed with water. By washing the negative electrode active material with water as described above, lithium carbonate (Li₂CO₃) 4 illustrated in FIG. 2C is removed from the surface of the negative electrode active material particle 1C.

### [Effect]

In the positive electrode active material according to the first embodiment, the elution of lithium can be suppressed since the amount of movable lithium is decreased using a compound capable of forming a complex with lithium. Hence, the negative electrode active material can be stabilized (safe). The negative electrode active material according to the first embodiment does not ignite even when being exposed to water and thus can also be used in an electrode containing a water-based binder.

In addition, a compound capable of forming a complex with lithium is present on the surface of the negative electrode active material, and it is thus possible to suppress an increase in SEI (Solid Electrolyte Interface) (namely, an increase in interface resistance)

In the method for manufacturing a positive electrode active material according to the first embodiment, it is possible to remove (chelate) movable lithium (excessively pre-doped lithium) in the pre-doped negative electrode active material particles by reacting a compound capable of forming a complex with lithium with negative electrode active material particles containing lithium. Hence, lithium elution can be suppressed.

In addition, it is possible to stabilize the initial charge and discharge efficiency by removing the movable lithium in the negative electrode active material particles. For example, the initial charge and discharge efficiency can be stabilized at 95% (error is less than 2%) in average.

In addition, movable lithium in the negative electrode active material particles can be removed by using a simple facility. The method for manufacturing a positive electrode active material according to the first embodiment is applicable not only to a powdery negative electrode active material but also to a thin film, an electrode and the like. It is difficult to handle a powdery negative electrode active material when the amount of residual lithium is great, and it is thus particularly preferable to apply the present art to a powdery negative electrode active material.

In addition, it is possible to achieve the capacity balance between the positive electrode and the negative electrode and to use a negative electrode active material which has been subjected to the expansion and contraction treatment in advance by removing the movable lithium in the negative electrode active material particles, and it is thus possible to improve the cycle characteristics.

### 2 Second Embodiment

In the second embodiment, a secondary battery including a negative electrode containing the negative electrode active material according to the first embodiment described above will be described.

### [Configuration of Battery]

Hereinafter, a configuration example of a secondary battery according to the second embodiment of the present art will be described with reference to FIG. 6. This secondary battery is, for example, a so-called lithium ion secondary battery in which the capacity of negative electrode is represented by a capacity component due to the storage and release of lithium (Li) which is an electrode reactant. This secondary battery is a so-called cylindrical secondary battery and has a wound electrode assembly 20 in which a pair of strip-shaped positive electrode 21 and strip-shaped negative electrode 22 are stacked with a separator 23 interposed therebetween and wound in an approximately hollow columnar battery can 11. The battery can 11 is composed of iron (Fe) plated with nickel (Ni), and one end portion thereof is closed and the other end portion thereof is opened. An electrolytic solution as a liquid electrolyte is injected into the interior of the battery can 11 and the positive electrode 21, the negative electrode 22, and the separator 23 are impregnated with the electrolytic solution. In addition, a pair of insulating plates 12 and 13 are respectively disposed perpendicularly with respect to the winding circumferential surface so as to sandwich the wound electrode assembly 20.

To the open end portion of the battery can 11, a battery lid 14, a safety valve mechanism 15 provided inside this battery lid 14, and a positive temperature coefficient element (PTC element) 16 are attached by being crimped with a sealing gasket 17 interposed therebetween. By this, the battery can 11 is sealed. The battery lid 14 is composed of, for example, the same material as that for the battery can 11. The safety valve mechanism 15 is electrically connected to the battery lid 14 and configured so that a disc plate 15A is inverted to cut off the electrical connection between the battery lid 14 and the wound electrode assembly 20 in a case in which the internal pressure of the battery is higher than a certain level by the internal short circuit, external heating and the like. The sealing gasket 17 is composed of, for example, an insulating material and the surface thereof is coated with asphalt.

For example, a center pin 24 is inserted at the center of the wound electrode assembly 20. A positive electrode lead 25 composed of aluminum (Al) and the like is connected to the positive electrode 21 of the wound electrode assembly 20, and a negative electrode lead 26 composed of nickel and the like is connected to the negative electrode 22. The positive electrode lead 25 is electrically connected to the battery lid 14 by being welded to the safety valve mechanism 15, and the negative electrode lead 26 is welded and electrically connected to the battery can 11.

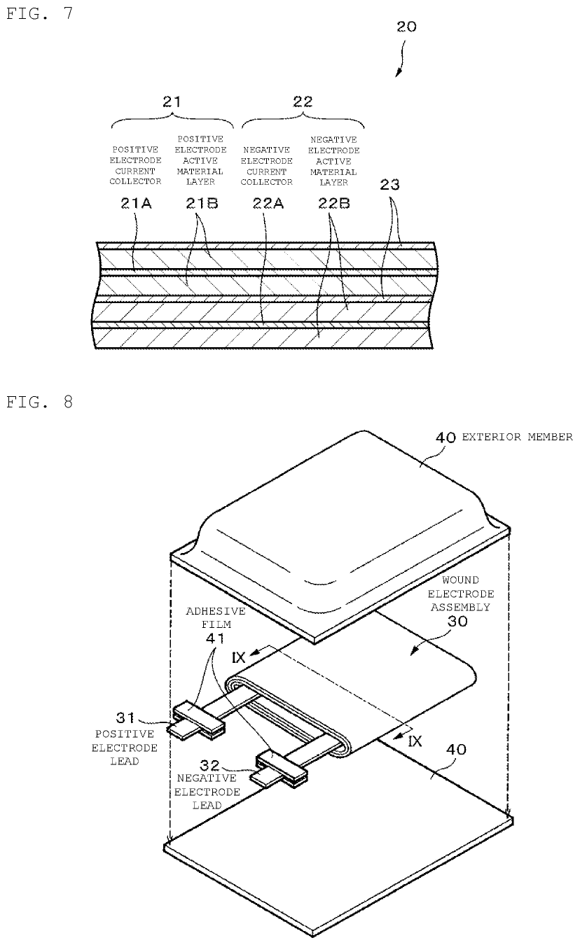

Hereinafter, the positive electrode 21, the negative electrode 22, the separator 23, and the electrolytic solution which constitute the secondary battery will be sequentially described with reference to FIG. 7.

### (Positive Electrode)

The positive electrode 21 has, for example, a structure in which a positive electrode active material layer 21B is provided on both sides of a positive electrode current collector 21A. Incidentally, the positive electrode active material layer 21B may be provided only on one side of the positive electrode current collector 21A although it is not illustrated. The positive electrode current collector 21A is composed of, for example, a metal foil such as an aluminum foil, a nickel foil, or a stainless steel foil. The positive electrode active material layer 21B contains, for example, a positive electrode active material capable of storing and releasing lithium as an electrode reactant. The positive electrode active material layer 21B may further contain additives if necessary. As the additives, for example, at least one of a conductive agent or a binder can be used.

As a positive electrode material capable of storing and releasing lithium, for example, a lithium-containing compound such as lithium oxide, lithium phosphorus oxide, lithium sulfide, or an intercalation compound containing lithium is suitable, and two or more of these may be used in mixture. In order to increase the energy density, a lithium-containing compound containing lithium, a transition metal element, and oxygen (O) is preferable. Examples of such a lithium-containing compound include a lithium composite oxide which has a layered rock salt type structure and is represented by Formula (A) and a lithium composite phosphate which has an olivine type structure and is represented by Formula (B). It is more preferable that the lithium-containing compound contains at least one selected from the group consisting of cobalt (Co), nickel, manganese (Mn), and iron as a transition metal element. Examples of such a lithium-containing compound include a lithium composite oxide which has a layered rock salt type structure and is represented by Formula (C), Formula (D), or Formula (E), a lithium composite oxide which has a spinel type structure and is represented by Formula (F), or a lithium composite phosphate which has an olivine type structure and is represented by Formula (G). Specifically, there are LiNi_{0.50}Co_{0.20}Mn_{0.30}O₂, LiₐCOO₂ (a≈1), Li_{b}CoO₂ (a≈1), Li_{c1}Ni_{c2}Co_{1-c2}O₂ (c1≈1, 0<c2<1), Li_{d}Mn₂O₄ (d≈1), LiₑFePO₄ (e≈1) or the like.

LiₚNi_{(1-q-r)}Mn_{q}M1ᵣO_{(2-y)}X_{z} (A)

(Provided that, in Formula (A), M1 represents at least one of elements selected from groups 2 to 15 excluding nickel and manganese. X represents at least one of a group 16 element or a group 17 element other than oxygen. p, q, y, and z are values in ranges of 0≤p≤1.5, 0≤q≤1.0, 0≤r≤1.0, −0.10≤y≤0.20, and 0≤z≤0.2.)

LiₐM2_{b}PO₄ (B)

(Provided that, in Formula (B), M2 represents at least one of elements selected from groups 2 to 15. a and b are values in ranges of 0≤a≤2.0 and 0.5≤b≤2.0.)

Li_{f}Mn_{(1-g-h)}Ni_{g}M3ₕO₍₂₋ⱼ₎Fₖ (C)

(Provided that, in Formula (C), M3 represents at least one selected from the group consisting of cobalt, magnesium (Mg), aluminum, boron (B), titanium (Ti), vanadium (V), chromium (Cr), iron, copper (Cu), zinc (Zn), zirconium (Zr), molybdenum (Mo), tin (Sn), calcium (Ca), strontium (Sr), and tungsten (W)). f, g, h, j, and k are values in ranges of 0.8≤f≤1.2, 0<g<0.5, 0≤h≤0.5, g+h<1, −0.1 j 0.2, and 0 k 0.1. Incidentally, the composition of lithium differs depending on the state of charge and discharge and the value of f represents the value in the fully discharged state.)

LiₘNi₍₁₋ₙ₎M4ₙO₍₂₋ₚ₎F_{q} (D)

(Provided that, in Formula (D), M4 represents at least one selected from the group consisting of cobalt, manganese, magnesium, aluminum, boron, titanium, vanadium, chromium, iron, copper, zinc, molybdenum, tin, calcium, strontium, and tungsten. m, n, p, and q are values in ranges of 0.8≤m≤1.2, 0.005≤n≤0.5, −0.1≤p≤0.2, and 0≤q≤0.1.

Incidentally, the composition of lithium differs depending on the state of charge and discharge and the value of m represents the value in the fully discharged state.)

LiᵣCo₍₁₋ₛ₎M5ₛO₍₂₋ₜ₎Fᵤ (E)

(Provided that, in Formula (E), M5 represents at least one selected from the group consisting of nickel, manganese, magnesium, aluminum, boron, titanium, vanadium, chromium, iron, copper, zinc, molybdenum, tin, calcium, strontium, and tungsten. r, s, t, and u are values in ranges of 0.8 r 1.2, 0≤s<0.5, −0.1≤t≤0.2, and 0≤u≤0.1.

Incidentally, the composition of lithium differs depending on the state of charge and discharge and the value of r represents the value in the fully discharged state.)

LiᵥMn_{2-w}M6_{w}OₓF_{y} (F)

(Provided that, in Formula (F), M6 represents at least one selected from the group consisting of cobalt, nickel, magnesium, aluminum, boron, titanium, vanadium, chromium, iron, copper, zinc, molybdenum, tin, calcium, strontium, and tungsten. v, w, x, and y are values in ranges of 0.9≤v≤1.1, 0≤w≤0.6, 3.7≤x≤4.1, and 0≤y≤0.1.

Incidentally, the composition of lithium differs depending on the state of charge and discharge and the value of v represents the value in the fully discharged state.)

Li_{z}M7PO₄ (G)

(Provided that, in Formula (G), M7 represents at least one selected from the group consisting of cobalt, manganese, iron, nickel, magnesium, aluminum, boron, titanium, vanadium, niobium (Nb), copper, zinc, molybdenum, calcium, strontium, tungsten, and zirconium. z is a value in a range of 0.9≤z≤1.1. Incidentally, the composition of lithium differs depending on the state of charge and discharge and the value of z represents the value in the fully discharged state.)

As the lithium composite oxide containing Ni, a lithium composite oxide (NCM) containing lithium, nickel, cobalt, manganese, and oxygen, a lithium composite oxide (NCA) containing lithium, nickel, cobalt, aluminum, and oxygen and the like may be used. Specifically, those represented by the following Formula (H) or Formula (I) may be used as the lithium composite oxide containing Ni.

Liᵥ₁Ni_{w1}M1′ₓ₁O_{z1} (H)

(Where 0<v1<2, w1+x1≤1, 0.2≤w1≤1, 0≤x1≤0.7, and 0<z<3 are satisfied, and M1′ represents at least one or more elements consisting of transition metals such as cobalt, iron, manganese, copper, zinc, aluminum, chromium, vanadium, titanium, magnesium, and zirconium.)

Liᵥ₂Ni_{w2}M2′ₓ₂O_{z2} (I)

(Where 0<v2<2, w2+x2≤1, 0.65≤w2≤1, 0≤x2≤0.35, and 0<z2<3 are satisfied, and M2′ represents at least one or more elements consisting of transition metals such as cobalt, iron, manganese, copper, zinc, aluminum, chromium, vanadium, titanium, magnesium, and zirconium.)

Examples of the positive electrode material capable of storing and releasing lithium also include inorganic compounds which do not contain lithium such as MnO₂, V₂O₅, V₆O₁₃, NiS, and MoS in addition to these.

The positive electrode material capable of storing and releasing lithium may be positive electrode materials other than those described above. In addition, two or more kinds of positive electrode materials exemplified above may be mixed by arbitrary combinations.

As the binder, for example, at least one selected from resin materials such as polyvinylidene fluoride (PVdF), polytetrafluoroethylene (PTFE), polyacrylonitrile (PAN), styrene-butadiene rubber (SBR), and carboxymethyl cellulose (CMC) and copolymers containing these resin materials as a main constituent is used.

Examples of the conductive agent include carbon materials such as graphite, carbon black, and ketjen black, and one among these may be used or two or more among these may be used in mixture. In addition to the carbon materials, a metal material, a conductive polymer material or the like may be used as long as the material exhibits conductivity.

### (Negative Electrode)

The negative electrode 22 has, for example, a structure in which a negative electrode active material layer 22B is provided on both sides of a negative electrode current collector 22A. Incidentally, the negative electrode active material layer 22B may be provided only on one side of the negative electrode current collector 22A although it is not illustrated. The negative electrode current collector 22A is composed of, for example, a metal foil such as a copper foil, a nickel foil, or a stainless steel foil.

The negative electrode active material layer 22B contains one or two or more negative electrode active materials capable of storing and releasing lithium. The negative electrode active material layer 22B may further contain additives such as a binder and a conductive agent if necessary.

Incidentally, in this secondary battery, it is preferable that the electrochemical equivalent of the negative electrode 22 or the negative electrode active material is greater than the electrochemical equivalent of the positive electrode 21 and the lithium metal is not deposited on the negative electrode 22 during charge in theory.

The negative electrode active material according to the first embodiment is used as the negative electrode active material. The negative electrode active material according to the first embodiment may be used together with a carbon material. In this case, excellent cycle characteristics can be obtained as well as high energy density can be obtained.

Examples of the carbon material to be used together with the negative electrode active material according to the first embodiment include carbon materials such as non-graphitizable carbon, graphitizable carbon, graphite, pyrolytic carbons, cokes, glassy carbons, organic polymer compound fired bodies, carbon fibers, or activated carbon. Among these, cokes include pitch coke, needle coke, or petroleum coke. Organic polymer compound fired bodies refer to a material obtained by firing and carbonizing a polymer material such as a phenol resin or furan resin at a proper temperature. Some of these are classified as non-graphitizable carbon orgraphitizable carbon. These carbon materials are preferable since a change in crystal structure thereof occurring at the time of charge and discharge significantly small and favorable cycle characteristics as well as high charge and discharge capacity can be obtained. In particular, graphite is preferable since graphite has a great electrochemical equivalent and high energy density can be obtained. In addition, non-graphitizable carbon is preferable since excellent cycle characteristics can be obtained. Furthermore, one having a low charge and discharge potential, specifically one having a charge and discharge potential close to that of lithium metal is preferable since high energy density of the battery can be easily realized.

As the binder, for example, at least one selected from resin materials such as polyvinylidene fluoride, polytetrafluoroethylene, polyacrylonitrile, styrene-butadiene rubber, and carboxymethyl cellulose and copolymers containing these resin materials as a main constituent is used. As the conductive agent, the same carbon material as that in the positive electrode active material layer 21B can be used.

### (Separator)

The separator 23 separates the positive electrode 21 and the negative electrode 22 from each other and allows lithium ions to pass there through while preventing a short circuit of current due to the contact of both electrodes. The separator 23 is composed of, for example, a porous membrane made of a resin such as polytetrafluoroethylene, polypropylene, or polyethylene and may have a structure in which these two or more kinds of porous membranes are laminated. Among these, polyolefin porous membrane is preferable since the polyolefin porous membrane exhibits an excellent short circuit preventing effect and can improve the safety of battery by a shutdown effect. In particular, polyethylene is preferable as a material constituting the separator 23 since a shutdown effect can be obtained in a range of 100° C. or more and 160° C. or less and polyethylene also exhibits excellent electrochemical stability. In addition to these, it is possible to use a material in which a resin exhibiting chemical stability is copolymerized or blended with polyethylene or polypropylene. Alternatively, the porous membrane may have a structure composed of three or more layers in which a polypropylene layer, a polyethylene layer, and a polypropylene layer are sequentially laminated.

The separator 23 may have a configuration including a substrate and a surface layer provided on one side or both sides of the substrate. The surface layer contains electrically insulating inorganic particles and a resin material which binds the inorganic particles to the surface of the substrate and binds the inorganic particles to each other. This resin material may have, for example, a fibrillated three-dimensional network structure in which fibrils are continuously connected to each other. The inorganic particles can be held in a dispersed state without being linked to each other by being supported on the resin material having this three-dimensional network structure. In addition, the resin material may bind the surface of the substrate and the inorganic particles without being fibrilized. In this case, higher binding property can be obtained. By providing the surface layer on one side or both sides of the substrate as described above, it is possible to impart oxidation resistance, heat resistance, and mechanical strength to the substrate.

The substrate is a porous layer exhibiting porosity. More specifically, the substrate is a porous membrane composed of an insulating membrane having a high ion permeability and a predetermined mechanical strength, and the electrolyte is retained in the holes of the substrate. It is preferable that the substrate has a predetermined mechanical strength as an essential part of the separator and is also required to exhibit high resistance to the electrolytic solution, low reactivity, and property to hardly expand.

As the resin material constituting the substrate, it is preferable to use, for example, a polyolefin resin such as polypropylene or polyethylene, an acrylic resin, a styrene resin, a polyester resin, or a nylon resin. In particular, polyethylenes such as low density polyethylene, high density polyethylene, and linear polyethylene, or low molecular weight wax components thereof or polyolefin resins such as polypropylene are suitably used since these have a proper melting temperature and are easily available. In addition, a structure in which two or more kinds of these porous membranes are laminated, or a porous membrane formed by melt-kneading two or more kinds of resin materials may be used. Those including a porous membrane composed of a polyolefin resin exhibit excellent property to separate the positive electrode 21 and negative electrode 22 from each other and can further decrease internal short circuits.

A non-woven fabric may be used as the substrate. As fibers constituting the non-woven fabric, aramid fibers, glass fibers, polyolefin fibers, polyethylene terephthalate (PET) fibers, nylon fibers and the like can be used. Moreover, the non-woven fabric may be fabricated by mixing two or more kinds of these fibers.

The inorganic particles contain at least one of a metal oxide, a metal nitride, a metal carbide, or a metal sulfide. As the metal oxide, aluminum oxide (alumina, Al₂O₃), boehmite (hydrated aluminum oxide), magnesium oxide (magnesia, MgO), titanium oxide (titania, TiO₂), zirconium oxide (zirconia, ZrO₂), silicon oxide (silica, SiO₂), yttrium oxide (yttria, Y₂O₃) or the like can be suitably used. As the metal nitride, silicon nitride (Si₃N₄), aluminum nitride (AlN), boron nitride (BN), titanium nitride (TiN) or the like can be suitably used. As the metal carbide, silicon carbide (SiC), boron carbide (B4C) or the like can be suitably used. As the metal sulfide, barium sulfate (BaSO₄) or the like can be suitably used. Moreover, porous aluminosilicates such as zeolite (M_{2/n}O·Al₂O₃·xSiO₂·yH₂O, M is a metal element, x≥2, and y≥0), layered silicates, minerals such as barium titanate (BaTiO₃) or strontium titanate (SrTiO₃) and the like may be used. Among these, alumina, titania (in particular, one having a rutile structure), silica, or magnesia is preferably used, and alumina is more preferably used. The inorganic particles exhibit oxidation resistance and heat resistance, and the surface layer on the side facing the positive electrode containing the inorganic particles exhibits high resistance to the oxidizing environment in the vicinity of the positive electrode at the time of charge. The shape of the inorganic particles is not particularly limited, and inorganic particles having any of a spherical shape, a plate shape, a fibrous shape, a cubic shape, or a random shape can be used.

Examples of the resin material constituting the surface layer include a fluorine-containing resin such as polyvinylidene fluoride or polytetrafluoroethylene, fluorine-containing rubber such as a vinylidene fluoride-tetrafluoroethylene copolymer or an ethylene-tetrafluoroethylene copolymer, rubber such as a styrene-butadiene copolymer or a hydride thereof, an acrylonitrile-butadiene copolymer or a hydride thereof, an acrylonitrile-butadiene-styrene copolymer or a hydride thereof, a methacrylic acid ester-acrylic acid ester copolymer, a styrene-acrylic acid ester copolymer, an acrylonitrile-acrylic acid ester copolymer, ethylene propylene rubber, polyvinyl alcohol, or polyvinyl acetate, cellulose derivatives such as ethyl cellulose, methyl cellulose, hydroxyethyl cellulose, and carboxymethyl cellulose, polyphenylene ether, polysulfone, polyether sulfone, polyphenylene sulfide, polyether imide, polyimide, polyamide such as wholly aromatic polyamide (aramid), polyamide imide, polyacrylonitrile, polyvinyl alcohol, polyether, and a resin exhibiting high heat resistance so that at least one of a melting point or a glass transition temperature is 180° C. or higher such as an acrylic resin or polyester. These resin materials may be used singly or two or more kinds thereof may be used in mixture. Among these, a fluorine-based resin such as polyvinylidene fluoride is preferable from the viewpoint of oxidation resistance and flexibility, and it is preferable to contain aramid or polyamideimide from the viewpoint of heat resistance.

The particle size of inorganic particles is preferably in a range of 1 nm to 10 μm. When the particle size is smaller than 1 nm, it is difficult to procure the inorganic particles and it is not cost effective even if the inorganic particles can be procured. On the other hand, when the particle size is larger than 10 μm, the distance between the electrodes increases, a sufficient filling amount of active material cannot be attained in a limited space, and the battery capacity decreases.

As a method for forming the surface layer, for example, it is possible to use a method in which a substrate (porous membrane) is coated with a slurry composed of a matrix resin, a solvent, and an inorganic material, and the coated substrate is allowed to pass through a tub containing a solvent which is a poor solvent of the matrix resin and a good solvent of the above solvent for phase separation, and then the coating film is dried.

Incidentally, the inorganic particles described above may be contained in the porous membrane as a substrate. In addition, the surface layer may be composed only of a resin material without containing inorganic particles.

### (Electrolytic Solution)

The separator 23 is impregnated with an electrolytic solution which is a liquid electrolyte. The electrolytic solution contains a solvent and an electrolyte salt dissolved in this solvent. The electrolytic solution may contain known additives in order to improve the battery characteristics.

As the solvent, cyclic carbonates such as ethylene carbonate and propylene carbonate can be used, and it is preferable to use one of ethylene carbonate or propylene carbonate, particularly, both of these in mixture. This is because the cycle characteristics can be improved.

As the solvent, it is preferable to use chain carbonates such as diethyl carbonate, dimethyl carbonate, ethylmethyl carbonate, and methylpropyl carbonate in mixture in addition to these cyclic carbonates. This is because high ion conductivity can be obtained.

It is preferable that the solvent further contains 2,4-difluoroanisole or vinylene carbonate. This is because 2,4-difluoroanisole can improve the discharge capacity and vinylene carbonate can improve the cycle characteristics. Hence, it is preferable to use these in mixture since the discharge capacity and cycle characteristics can be improved.

In addition to these, examples of the solvent include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxy acetonitrile, 3-methoxy propyronitrile, N,N-dimethylformamide, N-methyl pyrrolidinone, N-methyloxazolidinone, N,N-dimethylimidazolidinone, nitromethane, nitroethane, sulfolane, dimethyl sulfoxide, or trimethyl phosphate.

Incidentally, compounds obtained by substituting at least a part of hydrogen in these non-aqueous solvents with fluorine are preferable in some cases since there is a case in which the reversibility of electrode reaction can be improved depending on the kind of electrode to be combined.

Examples of the electrolyte salt include lithium salts. One kind may be used singly or two or more kinds may be used in mixture. Examples of the lithium salt include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro[oxolato-O,O′]borate, lithium bis(oxalate)borate, and LiBr. Among these, LiPF₆ is preferable since the cycle characteristics can be improved as well as high ion conductivity can be obtained.

### [Battery Voltage]

In the secondary battery according to the second embodiment, the open circuit voltage (namely, battery voltage) in the fully charged state for one pair of positive electrode 21 and negative electrode 22 may be 4.2 V or less, but the secondary battery may be designed so that the open circuit voltage is preferably 4.25 V or more, more preferably 4.3 V, and still more preferably 4.4 V or more. By setting the battery voltage high, high energy density can be obtained. The upper limit value of the open circuit voltage in the fully charged state for one pair of positive electrode 21 and negative electrode 22 is preferably 6.00 V or less, more preferably 4.60 V or less, and still more preferably 4.50 V or less.

### [Operation of Battery]

In the non-aqueous electrolyte secondary battery having the configuration described above, for example, lithium ions are released from the positive electrode active material layer 21B, pass through the electrolytic solution, and are stored in the negative electrode active material layer 22B when charge is performed. In addition, for example, lithium ions are released from the negative electrode active material layer 22B, pass through the electrolytic solution, and are stored in the positive electrode active material layer 21B when discharge is performed.

### [Method for Manufacturing Battery]

Next, an example of a method for manufacturing the secondary battery according to the second embodiment of the present art will be described.

First, for example, a positive electrode active material, a conductive agent, and a binder are mixed together to prepare a positive electrode mixture, and this positive electrode mixture is dispersed in a solvent such as N-methyl-2-pyrrolidone (NMP) to prepare a paste-like positive electrode mixture slurry. Next, the positive electrode current collector 21A is coated with this positive electrode mixture slurry, the solvent is dried, and compression molding is performed using a roll press machine or the like to form the positive electrode active material layer 21B, whereby the positive electrode 21 is fabricated.

In addition, for example, the negative electrode active material according to the first embodiment and a binder are mixed together to prepare a negative electrode mixture, and this negative electrode mixture is dispersed in a solvent such as N-methyl-2-pyrrolidone to prepare a paste-like negative electrode mixture slurry. Next, the negative electrode current collector 22A is coated with this negative electrode mixture slurry, the solvent is dried, and compression molding is performed using a roll press machine or the like to form the negative electrode active material layer 22B, whereby the negative electrode 22 is fabricated.

Next, the negative electrode lead 26 is attached to the negative electrode current collector 22A by welding or the like as well as the positive electrode lead 25 is attached to the positive electrode current collector 21A by welding or the like. Next, the positive electrode 21 and the negative electrode 22 are wound with the separator 23 interposed therebetween. Next, the tip portion of the negative electrode lead 26 is welded to the battery can 11 as well as the tip portion of the positive electrode lead 25 is welded to the safety valve mechanism 15, and the wound positive electrode 21 and negative electrode 22 are sandwiched between the pair of insulating plates 12 and 13 and accommodated inside the battery can 11. Next, after the positive electrode 21 and the negative electrode 22 are accommodated inside the battery can 11, the electrolytic solution is injected into the battery can 11 and the separator 23 is impregnates with the electrolytic solution. Next, the battery lid 14, the safety valve mechanism 15, and a positive temperature coefficient element 16 are fixed to the open end portion of the battery can 11 by being crimped with the sealing gasket 17 interposed therebetween. In this manner, the secondary battery illustrated in FIG. 6 is obtained.

### [Effect]

The battery according to the second embodiment includes the negative electrode 22 containing the negative electrode active material according to the first embodiment, and it is thus possible to stabilize the initial charge and discharge efficiency thereof and improve the cycle characteristics thereof. In addition, increases in average discharge voltage and impedance can be suppressed.

### 3 Third Embodiment

### [Configuration of Battery]

FIG. 7 is an exploded perspective diagram illustrating a configuration example of a secondary battery according to a third embodiment of the present art. This secondary battery is a so-called flatten or square type secondary battery, is a secondary battery in which a wound electrode assembly 30 to which a positive electrode lead 31 and a negative electrode lead 32 are attached is accommodated inside a film-shape exterior member 40, and can be miniaturized, decreased in weight, and thinned.

The positive electrode lead 31 and the negative electrode lead 32 are respectively led from the inside to the outside of the exterior member 40, for example, in the same direction. The positive electrode lead 31 and the negative electrode lead 32 are respectively composed of, for example, a metal material such as aluminum, copper, nickel, or stainless steel and respectively have a thin plate shape or a mesh shape.

The exterior member 40 is composed of, for example, a rectangular aluminum laminated film in which a nylon film, an aluminum foil, and a polyethylene film are pasted together in this order. The exterior member 40 is disposed, for example, so that the polyethylene film side and the wound electrode assembly 30 face each other, and the respective outer edge portions are closely stuck to each other by fusion or using an adhesive agent. An adhesive film 41 to prevent the outside air from entering is inserted between the exterior member 40 and the positive electrode lead 31 and negative electrode lead 32. The adhesive film 41 is composed of a material exhibiting adhesive property to the positive electrode lead 31 and the negative electrode lead 32, for example, a polyolefin resin such as polyethylene, polypropylene, modified polyethylene, or modified polypropylene.

Incidentally, the exterior member 40 may be composed of a laminated film having another structure, a polymer film such as polypropylene, or a metal film instead of the aluminum laminated film described above. Alternatively, a laminated film in which a polymer film is laminated on one side or both sides of an aluminum film as a core material may be used.

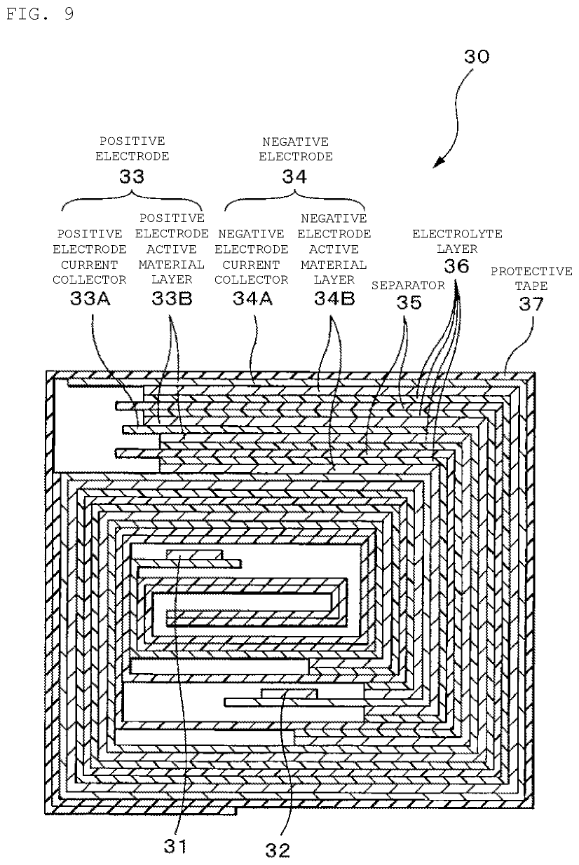

FIG. 8 is a cross-sectional diagram of the wound electrode assembly 30 taken along the line IV-IV in FIG. 7. The wound electrode assembly 30 is fabricated by stacking a positive electrode 33 and a negative electrode 34 with a separator 35 and an electrolyte layer 36 interposed therebetween and winding the stacked body, and the outermost circumferential portion is protected by a protective tape 37.

The positive electrode 33 has, for example, a structure in which a positive electrode active material layer 33B is provided on one side or both sides of a positive electrode current collector 33A. The negative electrode 34 has a structure in which a negative electrode active material layer 34B is provided on one side or both sides of a negative electrode current collector 34A, and the negative electrode active material layer 34B and the positive electrode active material layer 33B are disposed so as to face each other. The configurations of the positive electrode current collector 33A, positive electrode active material layer 33B, negative electrode current collector 34A, negative electrode active material layer 34B, and the separator 35 are the same as those of the positive electrode current collector 21A, positive electrode active material layer 21B, negative electrode current collector 22A, negative electrode active material layer 22B, and the separator 23 in the second embodiment, respectively.

The electrolyte layer 36 contains an electrolytic solution and a polymer compound to be a retainer which retains this electrolytic solution and is in a so-called gel state. The gel electrolyte layer 36 is preferable since it is possible to prevent liquid leakage from the battery as well as to obtain a high ion conductivity. The electrolytic solution is the electrolytic solution according to the first embodiment. Examples of the polymer compound include polyacrylonitrile, polyvinylidene fluoride, a copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene, or polycarbonate. In particular, polyacrylonitrile, polyvinylidene fluoride, polyhexafluoropropylene, or polyethylene oxide is preferable from the viewpoint of electrochemical stability.

Incidentally, the same inorganic material as the inorganic material mentioned in the description of the resin layer of the separator 23 in the second embodiment may be contained in the gel electrolyte layer 36. This is because the heat resistance can be further improved. Moreover, an electrolytic solution may be used instead of the electrolyte layer 36.

### [Method for Manufacturing Battery]

Next, an example of a method for manufacturing the secondary battery according to the third embodiment of the present art will be described.

First, the positive electrode 33 and the negative electrode 34 are each coated with a precursor solution containing a solvent, an electrolyte salt, a polymer compound, and a mixed solvent, and the mixed solvent is evaporated to form the electrolyte layer 36. Next, the negative electrode lead 32 is attached to the end portion of the negative electrode current collector 34A by welding as well as the positive electrode lead 31 is attached to the end portion of the positive electrode current collector 33A by welding. Next, the positive electrode 33 and negative electrode 34 on which the electrolyte layer 36 is formed are stacked with the separator 35 interposed therebetween to obtain a stacked body, then this stacked body is wound in the longitudinal direction, and the protective tape 37 is pasted to the outermost circumferential portion to form the wound electrode assembly 30. Finally, for example, the wound electrode assembly 30 is sandwiched between the exterior members 40, and the outer edge portions of the exterior member 40 are closely stuck to each other by heat seal and the like to seal the exterior member. At this time, the adhesive film 41 is inserted between the positive electrode lead 31 and negative electrode lead 32 and the exterior member 40. In this manner, the secondary battery illustrated in FIGS. 8 and 9 is obtained.

In addition, this secondary battery may be fabricated as follows. First, the positive electrode 33 and the negative electrode 34 are fabricated as described above, and the positive electrode lead 31 and the negative electrode lead 32 are attached to the positive electrode 33 and the negative electrode 34. Next, the positive electrode 33 and the negative electrode 34 are stacked with the separator 35 interposed therebetween, the stacked body is wound, and the protective tape 37 is pasted to the outermost circumferential portion to form a wound assembly. Next, this wound assembly is sandwiched between the exterior members 40, and the outer circumferential edge portion excluding one side is heat-sealed to have a bag shape, whereby the wound assembly is accommodated inside the exterior member 40. Next, a composition for electrolyte containing a solvent, an electrolyte salt, a monomer which is a raw material of a polymer compound, a polymerization initiator, and, if necessary, other materials such as a polymerization inhibitor, is prepared and injected into the exterior member 40.

Next, after the composition for electrolyte is injected into the exterior member 40, the opening of the exterior member 40 is hermetically sealed by heat seal in a vacuum atmosphere. Next, the monomer is polymerized by heating to obtain a polymer compound, whereby the gel electrolyte layer 36 is formed. In this manner, the secondary battery illustrated in FIG. 9 is obtained.

### EXAMPLES

Hereinafter, the present art will be specifically described with reference to Examples, but the present art is not limited only to these Examples.

Table 1 presents the configuration and preparation conditions of negative electrode active materials of Reference Examples 1-1, 1-2, 3-1, and 3-2 and Examples 1-1, 1-2, 3-1, and 3-2.

TABLE 1

| | | | | Presence or | Presence or | | | |
|---|---|---|---|---|---|---|---|---|
| | Shape of | Material | Presence or | absence of | absence of | | | |
| | active | for active | absence of | naphthalene | water | Color of | Image of | Coin cell |
| | material | material | pre-doping | treatment | washing | powder | particle | fabricated |
| Reference | Particle | SiOₓ | Absence | Absence | Absence | Reddish | FIG. 2A | Reference |
| Example 1-1 | | | | | | brown | | Example 2-1 |
| Reference | | Li-containing | Presence | Absence | Absence | Black | FIG. 2B | Reference |
| Example 1-2 | | SiOₓ | | | | | | Example 2-2 |
| Example 1-1 | | Li-containing | Presence | Presence | Absence | Black | FIG. 2C | Example 2-1 |
| | | SiOₓ | | | | | | |
| Example 1-2 | | Li-containing | Presence | Presence | Presence | Black | FIG. 2D | Example 2-2 |
| | | SiOₓ | | | | | | |
| Reference | Electrode | SiOₓ | Absence | Absence | Absence | — | — | Reference |
| Example 3-1 | | | | | | | | Example 4-1 |
| Reference | | Li-containing | Presence | Absence | Absence | — | — | Reference |
| Example 3-2 | | SiOₓ | | | | | | Example 4-2 |
| Example 3-1 | | Li-containing | Presence | Presence | Absence | — | — | Example 4-1 |
| | | SiOₓ | | | | | | |
| Example 3-2 | | Li-containing | Presence | Presence | Presence | — | — | Example 4-2 |
| | | SiOₓ | | | | | | |

### Reference Examples and Examples Using Amorphous SIOₓ Powder as Negative Electrode Active Material

### Reference Example 1-1

A powder of amorphous SiOₓ (manufactured by OSAKA Titanium technologies Co., Ltd.) was prepared, and this was referred to as Reference Example 1-1.

### Reference Example 1-2

### (Lithium Pre-Doping Dope: Naphthalene-Catalyzed Cycle)

First, 50 ml of tert-butyl methyl ether was placed in a 100 ml glass container, and 2 g of naphthalene was dissolved therein by performing mixing and stirring, thereby obtaining a clear colorless solution. Thereto, 1.7 g of metal lithium foil (0.8 mm in thickness) and 10 g of the negative electrode active material (SiOₓ powder) of Reference Example 1-1 were added and stirred for 24 hours using a magnetic stirrer to react the negative electrode active material and the solution. Hereinafter, this reaction process is referred to as a powder doping process. The entire procedure was performed in an argon-purged glove box.

After 24 hours elapsed, the lithium metal foil was completely dissolved and disappeared. This is because lithium continuously reacted with naphthalene through catalysis and finally the lithium metal foil was disappeared. The doping amount can be controlled by the amount of lithium metal introduced since approximately the entire lithium should react with naphthalene. At this time, the redox potential of lithium naphthalenide is about 0.3 V in theory, the lithium doping amount is stopped at a certain upper limit and excessive doping such as lithium deposition is avoided by the potential limitation even when the amount of lithium introduced is excessive. In a case in which lithium is deposited, naphthalene reacts with the deposited lithium and lithium deposition is eliminated. After the completion of reaction, the reaction solution was filtered, the lithium-doped negative electrode active material was taken out after being sealed, DMC washing and filtration were repeated two times in a dry room, and then vacuum drying was performed at 80° C. In this manner, the intended negative electrode active material was obtained.

### Example 1-1

### (Naphthalene Chelating)

First, the steps to the powder doping process were performed in the same manner as in Reference Example 1-2. Subsequently, the solution containing the negative electrode active material was allowed to still stand for 1 hour, and the brown or black supernatant was removed using a dropper. Thereafter, 50 ml of tert-butyl methyl ether and 5 g of naphthalene were added to the solution and stirring was performed for 5 hours. After stirring, the mixture was allowed to still stand for 1 hour, and the brown or black supernatant was removed using a dropper. The procedure was repeated until the supernatant was clear.

### (Drying Treatment)

After the naphthalene chelating treatment, the reaction solution was filtered or dried, the lithium-doped negative electrode active material was taken out after being sealed, DMC washing and filtration were repeated two times in a dry room, and then vacuum drying was performed at 80° C. In this manner, the intended negative electrode active material was obtained.

### Example 1-2

### (Water Washing Treatment)

The intended negative electrode active material was obtained in the same manner as in Example 1-1 except that the following water washing treatment step was further performed after the active material drying treatment. The negative electrode active material was brought out of the dry room, and the negative electrode active material and water were mixed together in a glass container. After it was confirmed that heat was not generated, the precipitate was taken out by centrifugation and dried. In this manner, the intended negative electrode active material was obtained. The water washing treatment should be performed after the naphthalene treatment was performed since the water washing treatment is dangerous. A case where the naphthalene treatment is not performed is dangerous since the negative electrode active material violently reacts with water. In addition, an alcohol washing treatment may be performed, but it is required to pay attention since there is a possibility of ignition.

### Example 2-1

A coin type half cell (hereinafter referred to as “coin cell”), which had a 2016 size (size having a diameter of 20 mm and a height of 1.6 mm) and included a negative electrode containing the negative electrode active material of Example 1-1 as a negative electrode active material as a working electrode and a lithium metal foil as a counter electrode, was fabricated as follows.

First, the negative electrode active material of Example 1-1, LiPAA (lithium polyacrylic acid), KS6 (carbon powder: manufactured by Imerys Graphite & Carbon), and DB (DENKA BLACK: manufactured by Denka Company Limited) were weighed so that the mass ratio (negative electrode active material:LiPAA:KS6:DB) was 8:1:0.75:0.25, and these were dispersed in a proper amount of N-methyl-2-pyrrolidone (NMP) to prepare a negative electrode mixture slurry.

Next, the prepared negative electrode mixture slurry was applied onto a copper foil (negative electrode current collector) and then dried at 125° C. in a vacuum firing furnace to form a negative electrode active material layer on the copper foil, whereby a negative electrode was obtained. Next, this negative electrode was punched into a circular shape having a diameter of 15 mm and then compressed using a press machine. In this manner, the intended negative electrode was obtained.

Next, a lithium metal foil punched into a circular shape having a diameter of 15 mm was prepared as a counter electrode. Next, a microporous polyethylene film was prepared as a separator. Next, a non-aqueous electrolytic solution was prepared by dissolving LiPF₆ as an electrolyte salt in a solvent in which ethylene carbonate (EC), fluoroethylene carbonate (FEC), and dimethyl carbonate (DMC) were mixed together so as to have a mass ratio (EC:FEC:DMC) of 40:10:50 so that the concentration of LiPF₆ was 1 mol/kg.

Next, the fabricated positive electrode and negative electrode were stacked with the microporous film interposed therebetween to obtain a stacked body, and the non-aqueous electrolytic solution was accommodated inside the exterior cup and the exterior can together with this stacked body and crimped with a gasket interposed therebetween. In this manner, the intended coin cell was obtained.

### Example 2-2

A coin cell was obtained in the same manner as in Example 3-1 except that the negative electrode active material of Example 1-2 was used instead of the negative electrode active material of Example 1-1.

### Reference Example 2-1

A coin cell was obtained in the same manner as in Example 3-1 except that the negative electrode active material of Reference Example 1-1 was used instead of the negative electrode active material of Example 1-1.

### Reference Example 2-2

A coin cell was obtained in the same manner as in Example 3-1 except that the negative electrode active material of Reference Example 1-2 was used instead of the negative electrode active material of Example 1-1.

### [Evaluation]

### (XPS)

The negative electrode active materials of Examples 1-1 and 1-2 and Reference Examples 1-1 and 1-2 were analyzed by XPS (X-ray Photoelectron Spectroscopy). The measuring instrument and measurement conditions are presented below.
Instrument: JEOL JPS9010
Measurement: wide scan, narrow scan (Si2p, C1s, O1s, Li1s).

All peaks were corrected at 248.4 eV of C1s, and the bonding state was analyzed by performing background elimination and peak fitting.

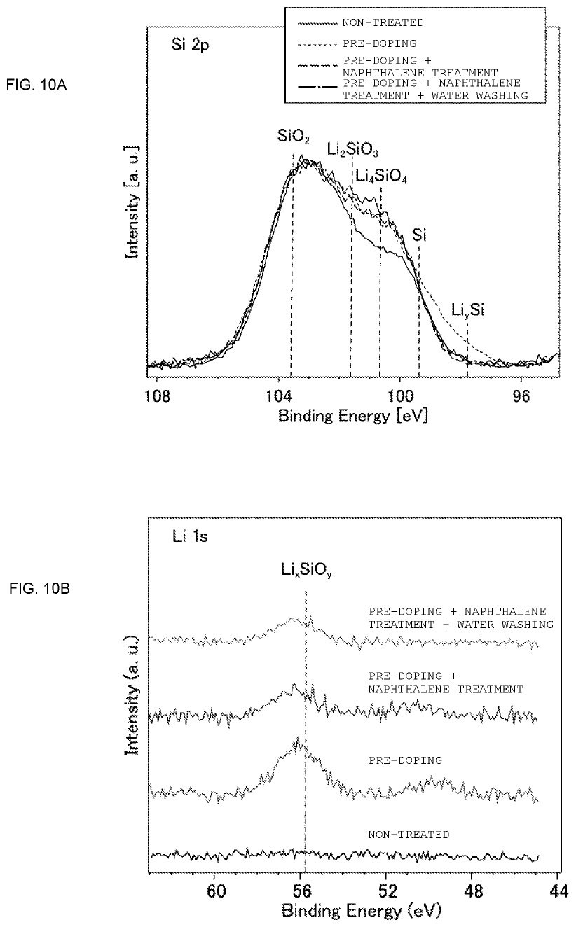

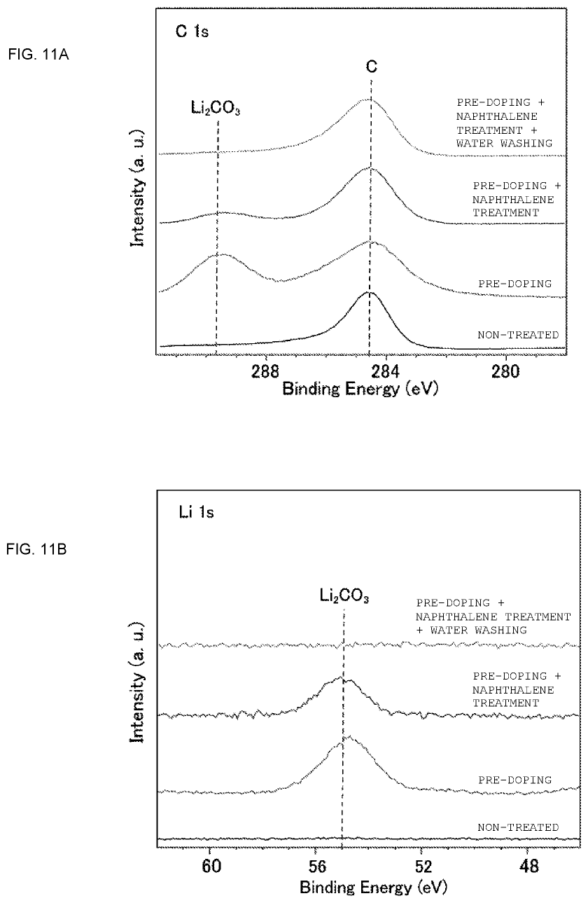

FIGS. 10A and 10B are graphs illustrating the XPS spectra (after Ar etching) of the interiors of negative electrode active materials of Examples 1-1 and 1-2 and Reference Examples 1-1 and 1-2. In the negative electrode active material (Reference Example 1-2) after being subjected to the pre-doping treatment, a shoulder (in the vicinity of 97.8 eV of Si2p) of Li_{y}Si indicating excessive doping is observed. On the other hand, in the negative electrode active material (Example 1-1) after being subjected to the naphthalene chelating treatment, it is confirmed that the silicate components of Li₄SiO₄ and Li₂SiO₃ was not changed and Li_{y}Si was disappeared. This demonstrates that it is possible to selectively remove Li_{y}Si by chelating treatment.

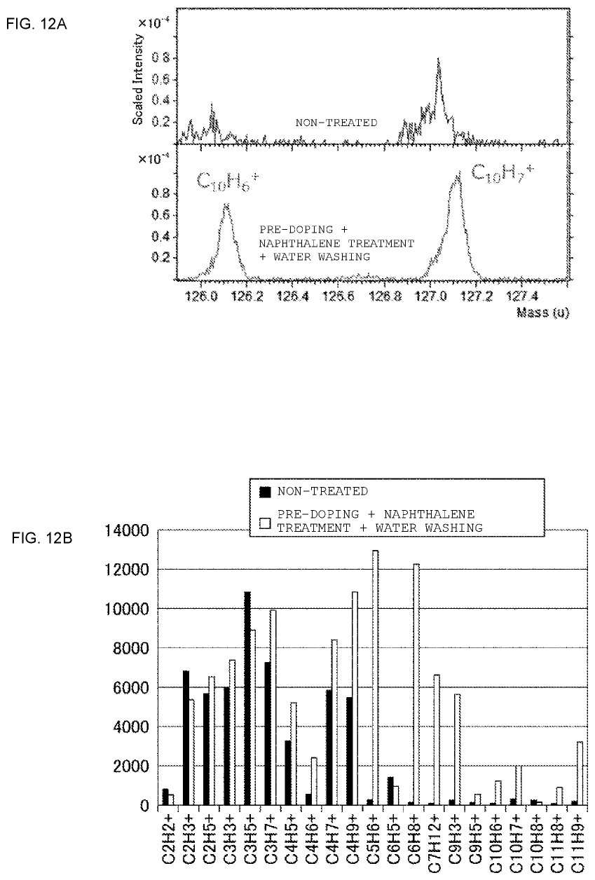

FIGS. 11A and 11B are graphs illustrating the XPS spectra of the surfaces of negative electrode active materials of Examples 1-1 and 1-2 and Reference Examples 1-1 and 1-2. It can be seen that lithium carbonate remains on the surfaces of negative electrode active materials (Reference Example 1-2 and Example 1-1) after being subjected to pre-doping and naphthalene treatment. This lithium carbonate is also confirmed by other methods such as electrochemical doping and thermal reaction doping, and adverse effects thereof such as binder solidification and gas generation are assumed. Hence, the water washing treatment was performed to remove lithium carbonate in Example 1-2. It can be seen from FIGS. 11A and 11B that lithium carbonate is removed by the water washing treatment. Moreover, it can also be seen from FIGS. 10A and 10B that a change in quality inside the negative electrode active material due to the water washing treatment is not observed.

By the naphthalene treatment, the Li_{y}Si removal is realized and lithium pre-doped SiOₓ can be handled in the air and in water. On the other hand, in the case of not performing the naphthalene treatment, there is a high risk of hydrogen generation and ignition due to lithium elution, and thus exposure to the atmosphere and introduction into water are contraindicated. Incidentally, materials other than naphthalene can also be used if lithium can be safely chelated without forming a by-product.

### (ToF-SIMS)

The negative electrode active materials of Example 1-2 and Reference Example 1-1 were analyzed by ToF-SIMS (Time-of-Flight Secondary Ion Mass Spectrometry). The measurement conditions are presented below.
Measurement conditions: Mass measurement of powder surface (positive, negative)

FIG. 12A is a graph illustrating the ToF-SIMS spectra of the surfaces of negative electrode active materials of Example 1-2 and Reference Example 1-1. FIG. 12B is a graph illustrating the results on the component analysis of the surfaces of negative electrode active materials of Example 1-2 and Reference Example 1-1 by ToF-SIMS. Naphthalene and hydrocarbon molecules, which are pre-doped precursors, are present on the surface of the negative electrode active material of Example 1-2. These organic molecule ligands are considered to have an effect of suppressing an increase in SEI (an increase in interfacial resistance). Incidentally, suppression of an increase in interfacial resistance will be described in the evaluation on cycle characteristics later.

### (Initial Charge and Discharge Characteristics)

The coin cells of Example 2-2 and Reference Examples 2-1 and 2-2 were subjected to a charge and discharge test under the following conditions, and the initial charge and discharge characteristics of the coin cells were examined.
Charge 0 V CCCV 0.05 C (0.04 mA cut), Discharge 1.5 V CC 0.05 C

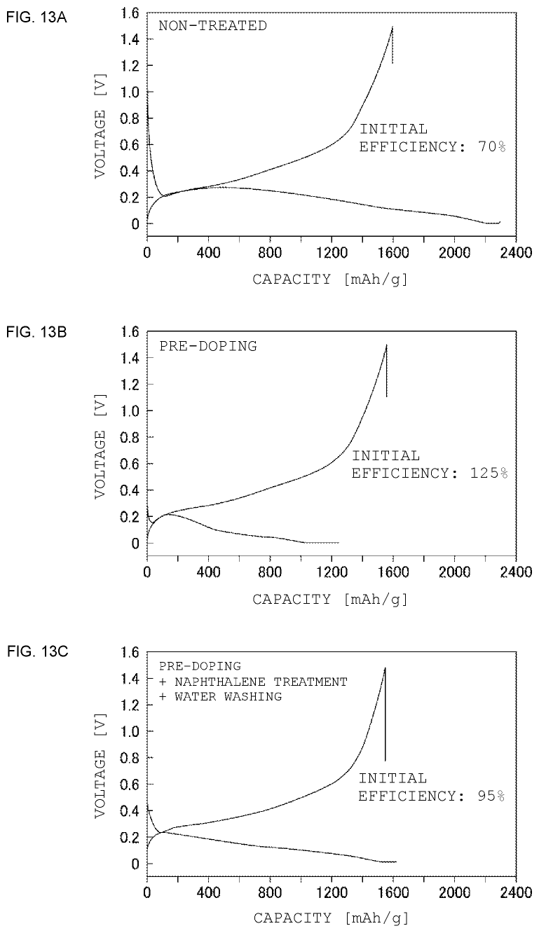

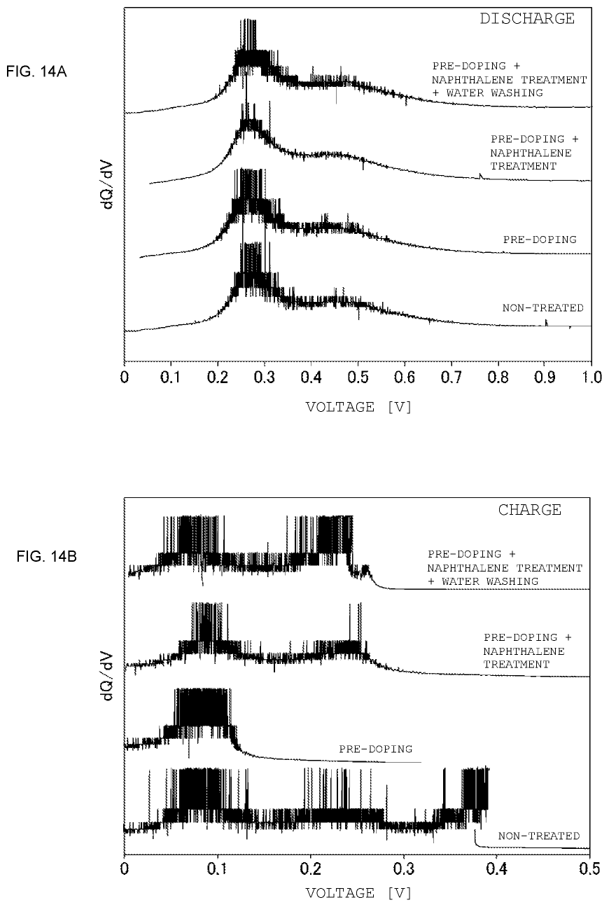

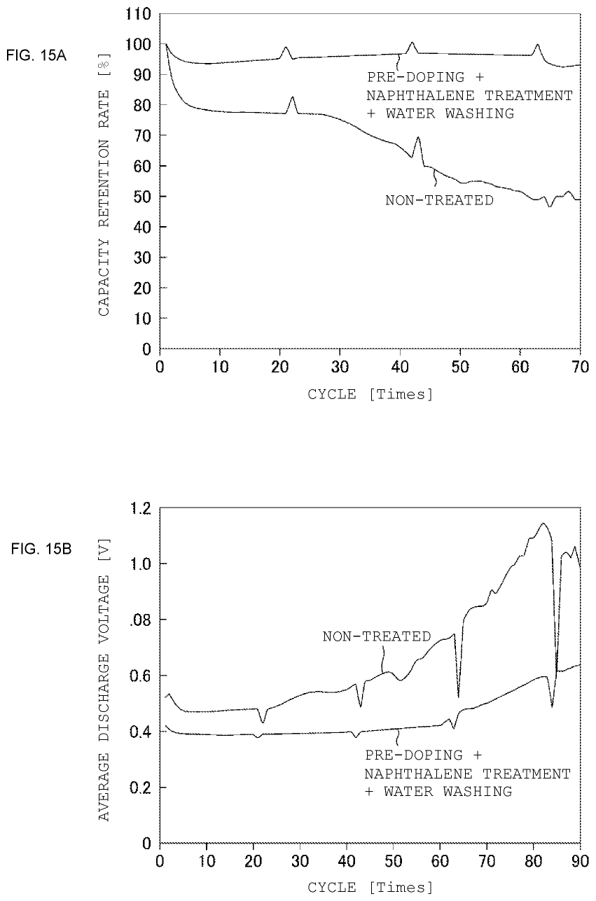

FIGS. 13A, 13B, and 13C are graphs illustrating the evaluation results on the initial charge and discharge characteristics of coin cells of Reference Examples 2-1 and 2-2 and Example 2-2, respectively. It can be seen that the coin cell (Reference Example 2-2) using a pre-doped negative electrode active material is over-doped as the initial charge and discharge efficiency thereof is 125%. In addition, the pre-doped negative electrode active material violently reacted with water and was over-doped. In other words, in the pre-doped negative electrode active material, it is considered that not only Li₄SiO₄ formation but also Li_{y}Si formation simultaneously occur as represented in Formula (4). It means that Li₄SiO₄ is preferentially generated from the perspective of potential but it is difficult to completely suppress Li_{y}Si formation.

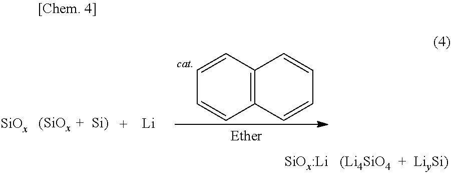

In the negative electrode active materials of Examples 1-1 and 1-2, it was attempted to utilize the reverse reaction of the above-described naphthalenide reaction. It is considered that the reaction potential of naphthalene with lithium is 1.86 V and it is possible to withdraw lithium from Li_{y}Si. In addition, it is also known that Li₄SiO₄ does not undergo discharge decomposition during discharge to 2 V, and thus only lithium doped onto Si can be selectively chelate-removed as represented in Formula (5).

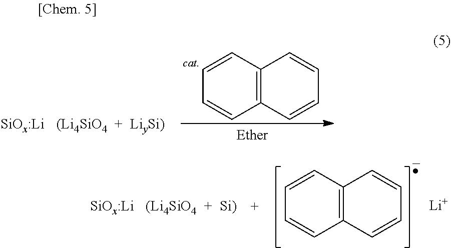

In the coin cell using the negative electrode active material (Example 2-2) from which Li_{y}Si was removed by the naphthalene treatment, the initial charge and discharge efficiency was stabilized at 95%. In addition, as presented in Table 1, the color of the powder of negative electrode active material changed from reddish brown to black by the pre-doping treatment and did not change from black by the naphthalene treatment.

(dQ/dV Curve)

The dQ/dV curves of coin cells of Examples 2-1 and 2-2 and Reference Examples 2-1 and 2-2 were measured.

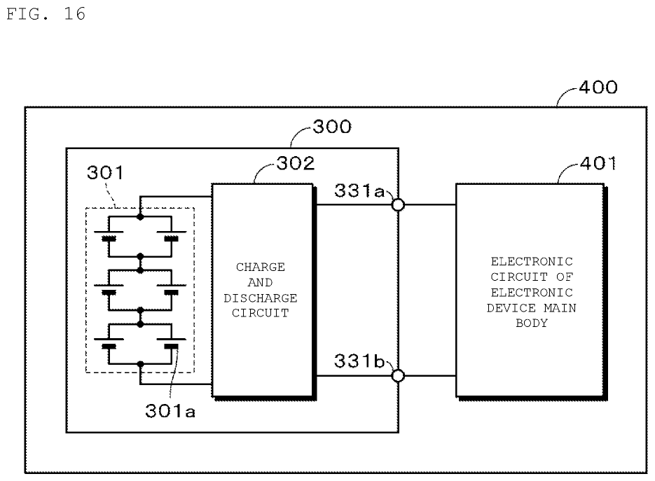

FIG. 14A is a graph illustrating the dQ/dV curves of coin cells of Examples 2-1 and 2-2 and Reference Examples 2-1 and 2-2 at the time of initial charge. FIG. 14B is a graph illustrating dQ/dV curves of coin cells of Examples 2-1 and 2-2 and Reference Examples 2-1 and 2-2 at the time of initial discharge.

The dQ/dV curves of all the coin cells of Examples 2-1 and 2-2 and Reference Examples 2-1 and 2-2 at the time of discharge roughly overlapped one another and differences were not found. On the other hand, in the dQ/dV curves at the time of charge, the high potential component (lithium silicate reaction) disappeared in the pre-doped Reference Example 2-1, and 0.2 to 0.3 V component (low concentration Li_{y}Si reaction) was resurrected in the naphthalene-treated Example 2-1. This data also supports the Li_{y}Si removal by the naphthalene treatment.

### (Cycle Characteristics)

The coin cells of Example 2-2 and Reference Example 2-1 were subjected to a charge and discharge test under the following conditions, and the cycle characteristics and average discharge voltage of the coin cells were examined.
1st cycle: Charge 0 V CCCV 0.05 C (0.04 mA cut), Discharge 1.5 V CC 0.05 C
After 2nd Cycle: Charge 0 V CCCV 0.5 C (0.04 mA cut), Discharge 1.5 V CC 0.5 C

### (Performance of Low Rate Charge and Discharge Test at 0.2 C Every 20 Cycles)

FIG. 15A is a graph illustrating the evaluation results on the cycle characteristics of coin cells of Example 2-2 and Reference Example 2-1. FIG. 15B is a graph illustrating the evaluation results on the average discharge voltage of coin cells of Example 2-2 and Reference Example 2-1. The capacity retention rate of the negative electrode active material (SiOₓ) subjected to the pre-doping, naphthalene treatment, and water washing is improved as compared to the capacity retention rate of the non-treated negative electrode active material (SiOₓ). In addition, in the negative electrode active material (SiOₓ) subjected to the pre-doping, naphthalene treatment, and water washing, increases in average discharge voltage and 1 kHz impedance are also suppressed. It is considered that this effect is exerted since an increase in interfacial resistance of the negative electrode active material is suppressed. It is considered that the suppression of an increase in interfacial resistance is caused by the presence of naphthalene and hydrocarbon-based molecules, which are pre-doped precursors, on the surface of the negative electrode active material as explained in the evaluation results on the component analysis by ToF-SIMS above.

In the present Examples, the reverse reaction of lithium naphthalenide was utilized as a method for suppressing the elution of lithium from the lithium pre-doped SiOₓ active material. It has been indicated that it is possible to remove Li_{y}Si by the naphthalene treatment and to remove lithium carbonate on the surface by water washing. The initial charge and discharge efficiency is stable at a significantly high numeral value of 95%, and a lithium pre-doped SiOₓ active material subjected to the naphthalene treatment can be handled in the air and in water. Moreover, it has also been indicated that the cycle characteristics can be improved by the pre-doping and naphthalene treatment.

### Reference Examples and Examples Using Amorphous SIOₓ Electrode as Negative Electrode Active Material

### Reference Example 3-1

An amorphous SiOₓ electrode was prepared, and this was referred to as Reference Example 3-1.

### Reference Example 3-2

### (Lithium Doping Process for Electrode: Lithium Naphthalenide Immersion Method)

First, 50 cc of tert-butyl methyl ether and 1.6 g of naphthalene were mixed and stirred together to dissolve naphthalene, thereby obtaining a clear colorless solution. Next, 0.1 g of 0.8 mm lithium foil was added to the solution, and stirring was performed for 5 hours using a stirrer to synthesize a brown or black lithium naphthalenide solution. The remaining lithium foil was removed. Thereafter, the negative electrode (SiOₓ electrode) of Reference Example 3-1 was introduced into the solution, and the negative electrode and the solution were reacted for 24 hours. Hereinafter, this reaction process is referred to as a negative electrode doping process. The work was performed in an Ar purged glove box. After the reaction, the lithium-doped negative electrode was taken out, filtered and washed with DMC in a dry room, and vacuum dried at 80° C. In this manner, the intended negative electrode was obtained.

### Example 3-1

### (Naphthalene Chelating)

First, the steps to the negative electrode doping process were performed in the same manner as in Reference Example 3-2. Subsequently, the solution containing the negative electrode was allowed to still stand for 1 hour, and the brown or black supernatant was removed using a dropper. Thereafter, 50 ml of tert-butyl methyl ether and 5 g of naphthalene were added to the solution and stirring was performed for 5 hours. After stirring, the mixture was allowed to still stand for 1 hour, and the brown or black supernatant was removed using a dropper. The procedure was repeated until the supernatant was clear.

### (Drying Treatment)

After the naphthalene chelating treatment, the negative electrode was sealed, taken out, repeatedly washed with DMC two times in a dry room, an then dried at 80° C. In this manner, the intended negative electrode was obtained.

### Example 3-2

### (Water Washing Treatment)

A negative electrode was obtained in the same manner as in Example 3-1 except that the following water washing treatment step was further performed after the negative electrode drying treatment. In other words, after being dried at 80° C., the negative electrode was brought out of the dry room, immersed in a glass container containing purity, and then vacuum dried at 120° C. In this manner, the intended negative electrode was obtained.

### Examples 4-1 and 4-2 and Reference Examples 4-1 and 4-2

Coin cells were fabricated in the same manner as in Example 2-1 except that the negative electrodes of Examples 3-1 and 3-2 and Reference Examples 3-1 and 3-2 were used as a negative electrode.

### [Evaluation]

The negative electrodes of Examples 3-1 and 3-2 and Reference Examples 3-1 and 3-2 were subjected to the same evaluation as that of the negative electrode active materials of Examples 1-1 and 1-2 and Reference Examples 1-1 and 1-2. As a result, in the negative electrodes of Examples 3-1 and 3-2 and Reference Examples 3-1 and 3-2, approximately the same evaluation results as those for the negative electrode active materials of Examples 1-1 and 1-2 and Reference Examples 1-1 and 1-2 were obtained.

In addition, the coin cells of Examples 4-1 and 4-2 and Reference Examples 4-1 and 4-2 were subjected to the same evaluation as that of the coin cells of Examples 2-1 and 2-2 and Reference Examples 2-land 2-2. As a result, in the coin cells of Examples 4-1 and 4-2 and Reference Examples 4-1 and 4-2, approximately the same evaluation results as those for the coin cells of Examples 2-1 and 2-2 and Reference Examples 2-1 and 2-2 were obtained.

### 4 Application Example 1

### Battery Pack and Electronic Device as Application Example

In Application Example 1, a battery pack and an electronic device which include the battery according to an embodiment or a modification thereof will be described.

### [Configuration of Battery Pack and Electronic Device]

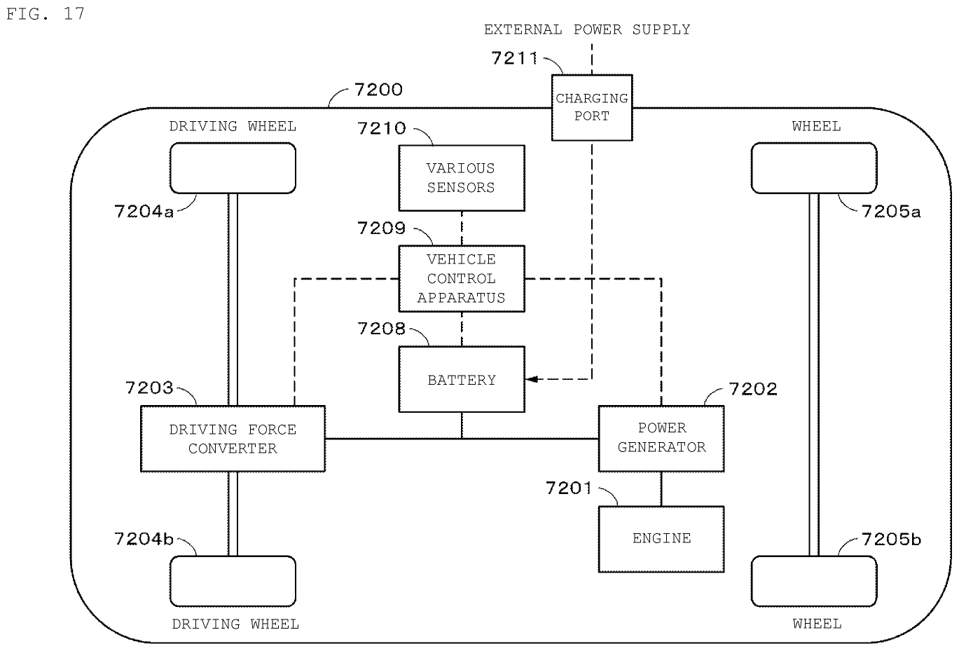

Hereinafter, a configuration example of a battery pack 300 and an electronic device 400 as an application example will be described with reference to FIG. 16. The electronic device 400 includes an electronic circuit 401 of the electronic device main body and the battery pack 300. The battery pack 300 is electrically connected to the electronic circuit 401 via a positive electrode terminal 331a and a negative electrode terminal 331b. The electronic device 400 has, for example, a configuration in which the battery pack 300 can be attached and detached by the user. Incidentally, the configuration of the electronic device 400 is not limited to this, but the electronic device 400 may have a configuration in which the battery pack 300 is incorporated in the electronic device 400 so that the battery pack 300 cannot be detached from the electronic device 400 by the user.

At the time of charge of the battery pack 300, the positive electrode terminal 331a and negative electrode terminal 331b of the battery pack 300 are connected to the positive electrode terminal and negative electrode terminal of a battery charger (not illustrated), respectively. On the other hand, at the time of discharge of the battery pack 300 (at the time of use of the electronic device 400), the positive electrode terminal 331a and negative electrode terminal 331b of the battery pack 300 are connected to the positive electrode terminal and negative electrode terminal of the electronic circuit 401, respectively.

Examples of the electronic device 400 include laptop personal computers, tablet computers, mobile phones (for example, smart phone), personal digital assistants (PDA), display devices (LCD, EL display, electronic paper and the like), imaging devices (for example, digital still camera and digital video camera), audio devices (for example, portable audio player), game devices, cordless phone handsets, e-books, electronic dictionaries, radios, headphones, navigation systems, memory cards, pacemakers, hearing aids, power tools, electric shavers, refrigerators, air conditioners, televisions, stereos, water heaters, microwaves, dishwashers, washing machines, dryers, lighting devices, toys, medical devices, robots, road conditioners, and traffic lights but are not limited to these.

### (Electronic Circuit)

The electronic circuit 401 includes, for example, a CPU, a peripheral logic unit, an interface unit, and a storage unit and controls the entire electronic device 400.

### (Battery Pack)

The battery pack 300 includes an assembled battery 301 and a charge and discharge circuit 302. The assembled battery 301 is configured by connecting a plurality of secondary batteries 301a in series and or in parallel. The plurality of secondary batteries 301a are connected, for example, n in parallel and m in series (n and m are positive integers). Incidentally, FIG. 16 illustrates an example in which six secondary batteries 301a are connected two in parallel and three in series (2P3S). As the secondary battery 301a, a battery according to an embodiment or a modification thereof is used.

Here, a case in which the battery pack 300 includes the assembled battery 301 configured of the plurality of secondary batteries 301a will be described, but a configuration in which the battery pack 300 includes one secondary battery 301a instead of the assembled battery 301 may be adopted.

The charge and discharge circuit 302 is a control unit which controls charge and discharge of the assembled battery 301. Specifically, at the time of charge, the charge and discharge circuit 302 controls charge with respect to the assembled battery 301. Meanwhile, at the time of discharge (namely, at the time of use of the electronic device 400), the charge and discharge circuit 302 controls discharge with respect to the electronic device 400.

### 5 Application Example 2

### Power Storage System in Vehicle as Application Example

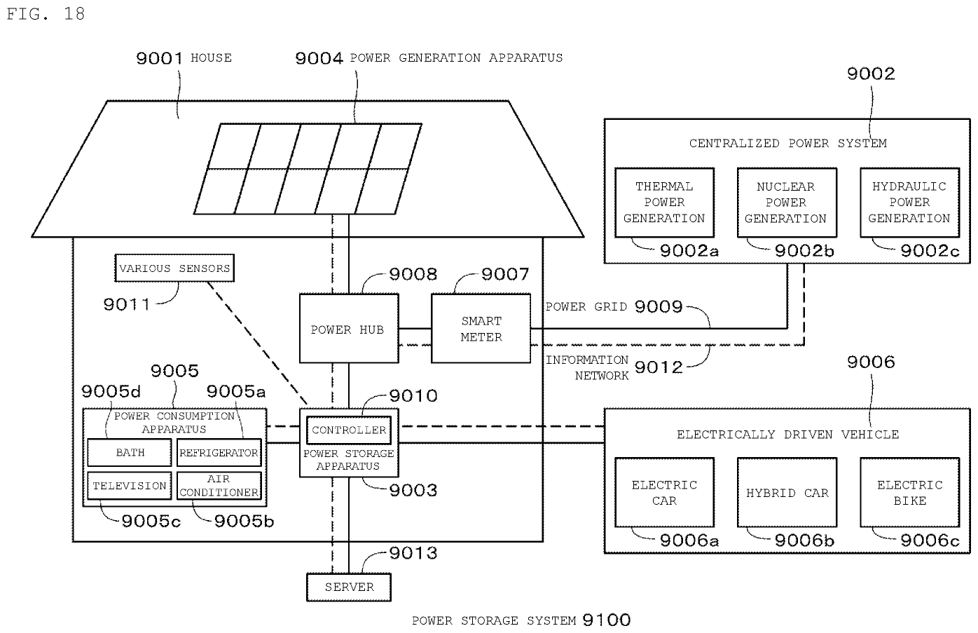

An example in which the present disclosure is applied to a power storage system for vehicle will be described with reference to FIG. 17. FIG. 17 schematically illustrates an example of a configuration of a hybrid vehicle which adopts a series hybrid system to which the present disclosure is applied. The series hybrid system is a vehicle which travels by a power to driving force converter using power generated by a power generator driven by an engine or power once stored in a battery.

On this hybrid vehicle 7200, an engine 7201, a power generator 7202, a power to driving force converter 7203, a driving wheel 7204a, a driving wheel 7204b, a wheel 7205a, and a wheel 7205b, a battery 7208, a vehicle control apparatus 7209, various sensors 7210, and a charging port 7211 are mounted. The power storage apparatus of the present disclosure described above is applied to the battery 7208.

The hybrid vehicle 7200 travels using the power to driving force converter 7203 as a power source. An example of the power to driving force converter 7203 is a motor. The power to driving force converter 7203 is operated by the power of the battery 7208, and the rotational force of this power to driving force converter 7203 is transmitted to the driving wheels 7204a and 7204b. Incidentally, the power to driving force converter 7203 can be applied to both an alternating current motor or a direct current motor by using direct current to alternating current (DC-AC) or invert conversion (AC to DC conversion) at necessary places. The various sensors 7210 control the engine speed via the vehicle control apparatus 7209 and control the opening degree (throttle opening degree) of a throttle valve (not illustrated). The various sensors 7210 include a speed sensor, an acceleration sensor, an engine speed sensor and the like.

The turning force of the engine 7201 is transmitted to the power generator 7202, and the power generated by the power generator 7202 by this turning force can be stored in the battery 7208.

When the hybrid vehicle is decelerated by a brake mechanism (not illustrated), the resistance force at the time of deceleration is applied to power to driving force converter 7203 as a turning force, and the regenerative power generated by the power to driving force converter 7203 by this turning force is stored in the battery 7208.

The battery 7208 can also receive power supply from the external power source using the charging port 211 as an input port and store the received power as the battery 7208 is connected to an external power source of the hybrid vehicle.

Although it is not illustrated, an information processing apparatus which performs information processing on the vehicle control based on the information on the secondary battery may be provided. As such an information processing apparatus, there is, for example, an information processing apparatus which displays the battery residual quantity based on the information on the residual quantity of battery.

Incidentally, in the above, a series hybrid vehicle which travels by a motor using the power generated by a power generator driven by an engine or power once stored in a battery has been described as an example. However, the present disclosure can also be effectively applied to parallel hybrid vehicles in which the outputs of the engine and motor are both used as the driving source and the three methods of traveling only by the engine, traveling only by the motor, and traveling by the engine and motor are appropriately switched and used. Furthermore, the present disclosure can be effectively applied to a so-called electrically driven vehicle which travels by driving only of a drive motor without using an engine.

An example of the hybrid vehicle 7200 to which the art according to the present disclosure can be applied has been described above. The art according to the present disclosure can be suitably applied to the battery 7208 among the configurations described above.

### 6 Application Example 3

### Power Storage System in House as Application Example

An example in which the present disclosure is applied to a power storage system for house will be described with reference to FIG. 18. For example, in a power storage system 9100 for a house 9001, power is supplied from a centralized power system 9002 such as thermal power generation 9002a, nuclear power generation 9002b, or hydraulic power generation 9002c to a power storage apparatus 9003 via a power grid 9009, an information network 9012, a smart meter 9007, a power hub 9008 and the like. Together with this, power is supplied from an independent power source such as a home power generation apparatus 9004 to the power storage apparatus 9003. The power supplied to the power storage apparatus 9003 is stored. The power storage apparatus 9003 is used to supply power to be used in the house 9001. The same power storage system can be used not only for the house 9001 but also for a building.

The house 9001 is provided with a power generation apparatus 9004, a power consumption apparatus 9005, the power storage apparatus 9003, a controller 9010 which controls the respective apparatuses, the smart meter 9007, and a sensor 9011 which acquires various kinds of information. The respective apparatuses are connected to one another by the power grid 9009 and the information network 9012. A solar cell, a fuel cell, and the like are utilized as the power generation apparatus 9004, and the generated power is supplied to the power consumption apparatus 9005 and/or the power storage apparatus 9003. The power consumption apparatus 9005 is a refrigerator 9005a, an air conditioner 9005b, a television receiver 9005c, a bath 9005d and the like. Furthermore, the power consumption apparatus 9005 includes an electrically driven vehicle 9006. The electrically driven vehicle 9006 is an electric car 9006a, a hybrid car 9006b, and an electric bike 9006c.

The battery unit of the present disclosure described above is applied to the power storage apparatus 9003. The power storage apparatus 9003 is configured of a secondary battery or a capacitor. For example, The power storage apparatus 9003 is configured of a lithium ion battery. The lithium ion battery may be a stationary type or one to be used in the electrically driven vehicle 9006. The smart meter 9007 has a function of measuring the quantity of commercial power consumed and transmitting the measured quantity of commercial power consumed to the power company. The power grid 9009 may be any one of direct current feed, alternating current feed, or non-contact feed or combination of a plurality of these.

The various sensors 9011 are, for example, a human sensor, an illuminance sensor, an object detection sensor, a power consumption sensor, a vibration sensor, a contact sensor, a temperature sensor, and an infrared sensor. The information acquired by the various sensors 9011 is transmitted to the controller 9010. By the information from the sensor 9011, the state of the weather, the state of a person and the like are grasped, the power consumption apparatus 9005 can be automatically controlled, and thus the energy consumption can be minimized. Furthermore, the controller 9010 can transmit the information on the house 9001 to the external power company and the like via the Internet.

The power hub 9008 performs processing such as branching of power lines and DC-AC conversion. As a communication method of the information network 9012 connected to the controller 9010, there are a method in which a communication interface such as UART (Universal Asynchronous Receiver-Transmitter) and a method in which a sensor network according to a wireless communication standard such as Bluetooth (registered trademark), ZigBee, and Wi-Fi is utilized. The Bluetooth system is applied to multimedia communication and can perform one-to-many communication. ZigBee uses a physical layer of IEEE (Institute of Electrical and Electronics Engineers) 802.15.4. IEEE 802.15.4 is a name of a short distance wireless network standard called PAN (Personal Area Network) or W (Wireless) PAN.

The controller 9010 is connected to an external server 9013. This server 9013 may be managed by any one of the house 9001, a power company, or a service provider. The information transmitted and received by the server 9013 is, for example, power consumption information, life pattern information, power rates, weather information, natural disaster information, and information on power transactions. These pieces of information may be transmitted and received from a home power consumption apparatus (for example, television receiver) but may be transmitted and received from an apparatus (for example, mobile phone) other than the house. These pieces of information may be displayed on devices having a display function, for example, a television receiver, a mobile phone, and Personal Digital Assistants (PDA).

The controller 9010 which controls the respective units is configured of a Central Processing Unit (CPU), Random Access Memory (RAM), Read Only Memory (ROM) and the like and is housed in the power storage apparatus 9003 in this example. The controller 9010 is connected to the power storage apparatus 9003, the home power generation apparatus 9004, the power consumption apparatus 9005, the various sensors 9011, the server 9013, and the information network 9012 and has, for example, a function of adjusting the quantity of commercial power consumed and the quantity of power generated. Incidentally, the controller 9010 may have a function of performing power transactions in the power market in addition to this.

As described above, power can be stored in the centralized power system 9002 such as the thermal power 9002a, the nuclear power 9002b, or the hydraulic power 9002c, in addition, the power generated by the home power generation apparatus 9004 (solar power generation, wind power generation) can be stored in the power storage apparatus 9003. Hence, control that the quantity of power to be transmitted to the outside is constantly maintained or discharge is performed if necessary can be performed even when the power generated by the home power generation apparatus 9004 fluctuates. For example, a method of use in which the midnight power with a low rate is stored in the power storage apparatus 9003 at night as well as the power obtained by solar power generation is stored in the power storage apparatus 9003, and the power stored in the power storage apparatus 9003 is discharged and consumed in a time zone in which the rate is high in the daytime.

Incidentally, an example in which the controller 9010 is housed in the power storage apparatus 9003 has been described in this example, but the controller 9010 may be housed in the smart meter 9007 or may be configured singly. Furthermore, the power storage system 9100 may be used for a plurality of houses in multiple dwelling or may be used for a plurality of detached houses.

An example of the power storage system 9100 to which the art according to the present disclosure can be applied has been described above. The art according to the present disclosure can be suitably applied to a secondary battery included in the power storage apparatus 9003 among the configurations described above.

Embodiments, modifications thereof, and Examples of the present art have been specifically described above, but the present art is not limited to the embodiments, modifications thereof, and Examples, and various modifications based on the technical ideas of the present art are possible.

For example, the configurations, methods, steps, shapes, materials, numerical values, and the like mentioned in the above-described embodiments, modifications thereof, and Examples are merely examples, and other configurations, methods, steps, shapes, materials, numerical values, and the like may be used if necessary. In addition, chemical formulas of compounds and the like are representative ones and are not limited to the indicated valences and the like as long as the names are the common names of the same compounds.

In addition, the configurations, methods, steps, shapes, materials, numerical values, and the like of the above-described embodiments, modifications thereof, and Examples can be combined with one another without departing from the spirit of the present art.

Moreover, an example in which the present art is applied to cylindrical and laminated film type secondary batteries has been described in the above-described embodiments and Examples, but the shape of battery is not particularly limited. For example, the present art can also be applied to a secondary battery such as a square type and a coin type, and the present art can also be applied to a smart watch, a head mounted display, a flexible battery mounted on a wearable terminal such as iGlass (registered trademark), and the like.

Moreover, an example in which the present art is applied to a wound battery has been described in the above-described embodiments and Examples, but the structure of battery is not particularly limited, and for example, the present art can also be applied to a secondary battery having a structure (stacked electrode structure) in which a positive electrode and a negative electrode are stacked, and a secondary battery having a structure in which a positive electrode and a negative electrode are folded.

Moreover, a configuration in which the electrodes (positive electrode and negative electrode) include a collector and an active material layer has been described as an example in the above-described embodiments and Examples, but the structure of electrode is not particularly limited. For example, a configuration in which the electrode is configured only of an active material layer may be adopted.

In addition, the positive electrode active material layer may be a green compact containing a positive electrode material or may be a sintered body of a green sheet containing a positive electrode material. The negative electrode active material layer may also be a green compact or a sintered body of a green sheet in the same manner.

Moreover, an example in which the present art is applied to a lithium ion secondary battery and a lithium ion polymer secondary battery has been described in the above-described embodiments and Examples, but the kind of battery to which the present art can be applied is not limited to this. For example, the present art may be applied to bulk-type all-solid-state batteries and the like.

In addition, the present art can also adopt the following configurations.

(1)

A negative electrode active material having a compound capable of forming a complex with lithium on a surface.

(2)

The negative electrode active material according to (1), containing lithium;
at least one of silicon, tin, or germanium; and
at least one of oxygen or fluorine.
   (3)

The negative electrode active material according to (1) or (2), containing at least one of lithium-containing SiOₓ (0.33<x<2), lithium-containing SnO_{y} (0.33≤y≤2), or lithium-containing GeO_{z} (0.33<z<2)

(4)

The negative electrode active material according to (2) or (3), in which a content of lithium is 10 at % or more and 45 at % or less.

(5)

The negative electrode active material according to any one of (1) to (4), in which the compound is at least one of an aromatic compound or a derivative of the aromatic compound.

(6)

The negative electrode active material according to (5), in which the aromatic compound is at least one of naphthalene, anthracene, tetracene, or pentacene.

(7)

The negative electrode active material according to any one of (1) to (6), having a particulate shape, a layered shape, or a three-dimensional shape.

(8)

The negative electrode active material according to claim 1, containing a covering agent covering at least a part of the surface, in which
the covering agent contains at least one of carbon, a hydroxide, an oxide, a carbide, a nitride, a fluoride, a hydrocarbon compound, or a polymer compound.
   (9)

The negative electrode active material according to (8), in which a content of the covering agent is 0.05 mass % or more and 10 mass % or less.

(10)

A method for manufacturing a negative electrode active material, including reacting a compound capable of forming a complex with lithium with a negative electrode active material containing lithium.

(11)

The method for manufacturing a negative electrode active material according to (10), in which the reaction is performed by immersing the negative electrode active material in a solution containing the compound.

(12)

A negative electrode containing the negative electrode active material according to (1).

(13)

A battery including:
a negative electrode containing the negative electrode active material according to (1);
a positive electrode; and
an electrolyte.
   (14)

A battery pack including:
the battery according to (13); and
a control unit configured to control the battery.
   (15)

An electronic device including the battery according to (13), in which
the electronic device receives power supply from the battery.
   (16)

An electrically driven vehicle including:
the battery according to (13);
a converter configured to receive power supply from the battery and convert the power into a driving force of the vehicle; and
a controller configured to perform information processing on vehicle control based on information on the battery.
   (17)

A power storage apparatus including the battery according to (13), in which
the power storage apparatus supplies power to an electronic device connected to the battery.
   (18)

The power storage apparatus according to (17), including a power information controller configured to transmit and receive a signal to and from another device via a network, in which
charge and discharge control of the battery is performed based on information received by the power information controller.
   (19)

A power system including the battery according to (13), in which
the power system receives power supply from the battery.
   (20)

The power system according to (19), in which power is supplied from a power generation apparatus or a power grid to the battery.

### DESCRIPTION OF REFERENCE SYMBOLS

11: Battery can
12, 13: Insulating plate
14: Battery lid
15: Safety valve mechanism
15A: Disc plate
16: Positive temperature coefficient element
17: Gasket
20: Wound electrode assembly
21: Positive electrode
21A: Positive electrode current collector
21B: Positive electrode active material layer
22: Negative electrode
22A: Negative electrode current collector
22B: Negative electrode active material layer
23: Separator
24: Center pin
25: Positive electrode lead
26: Negative electrode lead

1. A method for manufacturing a negative electrode active material, comprising
reacting a compound capable of forming a complex with lithium and a negative electrode active material containing lithium and silicon.

2. The method for manufacturing the negative electrode active material according to claim 1, wherein the reaction is performed by immersing the negative electrode active material in a solution containing the compound and lithium.

3. The method for manufacturing the negative electrode active material according to claim 1, further comprising immerging the negative electrode active material in a solution containing the compound and substantially not containing lithium.

4. The method for manufacturing the negative electrode active material according to claim 1, further comprising water washing the negative electrode active material.

5. The method for manufacturing the negative electrode active material according to claim 1, wherein the compound is at least one of an aromatic compound or a derivative of the aromatic compound.

6. The method for manufacturing the negative electrode active material according to claim 5, wherein the aromatic compound is at least one of naphthalene, anthracene, tetracene, or pentacene.
